(19) United States
(12) Patent Application Publication
(10) Pub. No.: US 2021/0298519 A1
(43) Pub. Date: Sep. 30, 2021

(54) AUTOMATED, COMPUTER-CONTROLLED, COOKING SYSTEM AND METHOD

(71) Applicant: Genie Enterprise, Ltd., Rishpon (IL)

(72) Inventors: Doron Marco, Tel Aviv (IL); Ayelet Carasso, Tel Aviv (IL); Ben Galazan, Tel Aviv (IL)

(21) Appl. No.: 17/266,010

(22) PCT Filed: Aug. 7, 2018
(86) PCT No.: PCT/IL2018/050871

§ 371 Date: Feb. 4, 2021

(51) Int. Cl. A47J 36/32; A47J 27/08; A47J 27/00; A47J 36/16; A23L 5/10; A47J 44/00; H05B 6/68; G07C 3/14; G05B 19/042

(52) U.S. Cl. CPC A47J 36/321; A47J 27/08; A47J 27/004; A47J 36/165; A23L 5/15; A23L 5/13; G05B 2219/2643; H05B 6/687; G07C 3/143; G07C 3/146; G05B 19/042; A23V 2002/00; A47J 44/00

(57) ABSTRACT

An automated, computer-controlled, cooking system for use with user selectable ones of a plurality of different pre-sealed computerized cooking containers containing dry contents (PSCCCCDC) useful in preparing corresponding different food products, the system including a microwave radiation generator, a PSCCCCDC support for supporting a user-selected one of the plurality of different PSCCCCDCs during cooking, a computer-controlled liquid supply subsystem for supplying liquid to the selected PSCCCCDC, a computer-controlled stirrer subsystem for producing stirring of the dry contents of the PSCCCCDC together with the liquid, a cooking instructions input interface for receiving PSCCCCDC specific cooking instructions and a computer controller operative to control operation of at least the computer-controlled liquid supply subsystem, the computer-controlled stirrer subsystem and the microwave radiation generator in a predetermined sequence corresponding to and specifically adapted for cooking the contents of the selected PSCCC-CDC in accordance with the PSCCCCDC specific cooking instructions.

### REFERENCE TO RELATED APPLICATIONS

Reference is hereby made to the following U.S. and PCT Patent Applications, the disclosures of which are hereby incorporated by reference:

U.S. patent application Ser. No. 14/208,670 entitled AUTOMATED ON DEMAND BAKING SYSTEM, filed Mar. 13, 2014;

U.S. patent application Ser. No. 14/942,149 entitled APPARATUS FOR RAPID HEATING OF LIQUIDS, filed Nov. 16, 2015; and

PCT Patent Application PCT/IL2017/050195 entitled AUTOMATED, COMPUTER-CONTROLLED COOKING SYSTEM AND METHOD, filed Feb. 15, 2017.

### FIELD OF THE INVENTION

The present invention relates to automated cooking systems and methodologies generally and to meal precursors specifically constructed for use in such automated cooking systems and methodologies.

### BACKGROUND OF THE INVENTION

Various types of automated cooking systems and methodologies are known.

### SUMMARY OF THE INVENTION

The present invention seeks to provide improved automated cooking systems and methods.

There is thus provided in accordance with a preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave radiation generator, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid, a cooking instructions input interface for receiving PSCCCCDC specific cooking instructions and a computer controller operative to control operation of at least the computer-controlled liquid supply subsystem, the computer-controlled stirrer subsystem and the microwave radiation generator in a predetermined sequence corresponding to and specifically adapted for cooking the contents of the user-selected one of the plurality of different PSCCCCDCs in accordance with the PSCCCCDC specific cooking instructions.

In accordance with a preferred embodiment of the present invention the predetermined sequence defines a computer implementable cooking protocol which includes a sequence of cooking sub-protocols each of which defines at least one parameter relating to operation of the microwave radiation generator and at least one of at least one parameter relating to operation of the computer-controlled liquid supply subsystem and at least one parameter relating to operation of the computer-controlled stirrer subsystem. Alternatively, the predetermined sequence defines a computer implementable cooking protocol which includes a sequence of cooking sub-protocols each of which defines at least one parameter relating to operation of the microwave radiation generator and at least one parameter relating to operation of the computer-controlled liquid supply subsystem.

Preferably, the predetermined sequence defines a computer implementable cooking protocol which includes a sequence of cooking sub-protocols each of which defines at least one parameter relating to operation of the microwave radiation generator and at least one parameter relating to operation of the computer-controlled stirrer subsystem. Alternatively, the predetermined sequence defines a computer implementable cooking protocol which includes a sequence of cooking sub-protocols each of which defines at least one parameter relating to operation of the microwave radiation generator, at least one parameter relating to operation of the computer-controlled liquid supply subsystem and at least one parameter relating to operation of the computer-controlled stirrer subsystem.

In accordance with a preferred embodiment of the present invention the computer-controlled liquid supply subsystem for supplying liquid to the user selected one of the plurality of different PSCCCCDCs includes a first water pump for pumping cold water and at least one second water pump for pumping heated water. Additionally or alternatively, the computer-controlled liquid supply subsystem for supplying liquid to the user selected one of the plurality of different PSCCCCDCs includes a heated water and/or steam generator.

In accordance with a preferred embodiment of the present invention the computer-controlled stirrer subsystem for producing stirring of the dry contents of the PSCCCCDC together with the liquid is operative to effect stirring of contents of the user selected PSCCCCDC by moving the PSCCCCDC vertically. Additionally or alternatively, the computer-controlled stirrer subsystem for producing stirring of the dry contents of the PSCCCCDC together with the liquid includes a rotary drive motor and a linkage which are together operative to displace the PSCCCCDC support in reciprocal vertical motion.

There is also provided in accordance with another preferred embodiment of the present invention an automated, computer-controlled, cooking system for use with user selectable ones of a plurality of different pre-sealed computerized cooking containers containing dry contents (PSCCCCDCs) useful in preparing corresponding different food products, the system including a microwave radiation generator and a computer-controlled stirrer subsystem for producing stirring of the dry contents of the PSCCCCDC together with a liquid by moving the PSCCCCDC vertically.

Preferably, the automated, computer-controlled, cooking system also includes a computer-controlled liquid supply subsystem for supplying heated liquid to the user selected one of the plurality of different PSCCCCDCs. Additionally or alternatively, the automated, computer-controlled, cooking system also includes a computer controller operative to control operation of at least the microwave radiation generator in a predetermined sequence corresponding to and specifically adapted for cooking the contents of the user-selected one of the plurality of different PSCCCCDCs.

In accordance with a preferred embodiment of the present invention the automated, computer-controlled, cooking system also includes a computer controller operative to control operation of at least the microwave radiation generator in a predetermined sequence corresponding to and specifically adapted for cooking the contents of the user-selected one of the plurality of different pre-sealed PSCCCCDCs.

There is further provided in accordance with yet another preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave radiation generator, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled stirrer subsystem external of the PSCCCCDC support for accelerating the PSCCCCDC support vertically and thus producing stirring of the dry contents of the PSCCCCDC together with the liquid.

In accordance with a preferred embodiment of the present invention the computer-controlled stirring subsystem is operative to accelerate the PSCCCCDC to a computer-controlled extent and with timing, which is computer coordinated with operation of the microwave radiation generator. Additionally or alternatively, the automated, computer-controlled, cooking system also includes a computer controller operative to control operation of the microwave radiation generator, the computer-controlled liquid supply subsystem for supplying liquid to the user selected one of the plurality of different PSCCCCDCs and the computer-controlled stirrer subsystem external of the PSCCCCDC support in a predetermined sequence corresponding to and specifically adapted for cooking the contents of the user-selected one of the plurality of different PSCCCCDCs.

There is yet further provided in accordance with still another preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave radiation generator, a PSCCCCDC support for supporting a user selected one of the plurality of different PSCCCCDCs during cooking, a computer-controlled liquid supply subsystem for supplying liquid to the user selected one of the plurality of different PSCCCCDCs and a computer-controlled PSCCCCDC support displacer for vertically displacing the PSCCCCDC support and stirring the contents of the PSCCCCDC by vertical acceleration thereof.

There is still further provided in accordance with yet another preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave radiation generator, a computer-controlled PSCCCCDC support assembly for vertically displacing a user selected one of the plurality of different PSCCCCDCs during cooking and a computer-controlled liquid supply subsystem for supplying heated liquid to the user selected one of the plurality of different PSCCCCDCs.

Preferably, the automated, computer-controlled, cooking system also includes a computer controller operative to control operation of at least the computer-controlled PSCCCCDC support assembly and the computer-controlled liquid supply subsystem in a predetermined sequence corresponding to and specifically adapted for cooking the contents of the user-selected one of the plurality of different PSCCCCDCs. Additionally, the predetermined sequence defines a computer implementable cooking protocol which includes a sequence of cooking sub-protocols each of which defines at least one parameter relating to operation of the computer-controlled PSCCCCDC support assembly and at least one parameter relating to operation of the computer-controlled liquid supply subsystem.

In accordance with a preferred embodiment of the present invention the automated, computer-controlled, cooking system for use with user selectable ones of a plurality of different PSCCCCDCs useful in preparing corresponding different food products also includes a remotely and wirelessly programmable computer controller operative to control operation of at least the computer-controlled liquid supply subsystem, the computer-controlled stirrer subsystem and the microwave radiation generator in a predetermined sequence corresponding to and specifically adapted for cooking the contents of the user-selected one of the plurality of different PSCCCCDCs.

There is also provided in accordance with another preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave radiation generator, a PSCCCCDC support for supporting a user-selected one of the plurality of different PSCCCCDCs during cooking, a computer-controlled liquid supply subsystem for supplying liquid to the user selected one of the plurality of different PSCCCCDCs, a computer-controlled stirrer subsystem for producing stirring of the dry contents of the PSCCCCDC together with the liquid by displacement of the PSCCCCDC support and a remotely and wirelessly programmable computer controller operative to control operation of at least the computer-controlled liquid supply subsystem, the computer-controlled stirrer subsystem and the microwave radiation generator in a predetermined sequence corresponding to and specifically adapted for cooking the contents of the user-selected one of the plurality of different PSCCCCDCs.

In accordance with a preferred embodiment of the present invention the remotely and wirelessly programmable computer controller is operative to control the operation based partially on user inputs received wirelessly and partially on the predetermined sequence.

In accordance with a preferred embodiment of the present invention the automated, computer-controlled, cooking system for use with user selectable ones of a plurality of different PSCCCCDCs useful in preparing corresponding different food products also includes a computer-controlled quality-controller operative to ascertain whether operation of at least the computer-controlled liquid supply subsystem, the computer-controlled stirrer subsystem and the microwave radiation generator actually took place in a predetermined sequence specifically adapted for cooking the contents of the user-selected one of the plurality of different PSCCCCDCs and to provide a corresponding quality control output indication.

There is further provided in accordance with yet another preferred embodiment of the present invention an automated, computer-controlled, cooking system for use with user selectable ones of a plurality of different pre-sealed computerized cooking containers containing dry contents (PSCCCCDC) useful in preparing corresponding different food products, the system including a microwave radiation generator, a PSCCCCDC support for supporting a user-selected one of the plurality of different PSCCCCDCs during cooking, a computer-controlled liquid supply subsystem for supplying liquid to the user-selected one of the plurality of different PSCCCCDCs, a computer-controlled stirrer subsystem for producing stirring of the dry contents of the PSCCCCDC together with the liquid by displacement of the PSCCCCDC support and a computer-controlled quality-controller operative to ascertain whether operation of at least the computer-controlled liquid supply subsystem, the computer-controlled stirrer subsystem and the microwave radiation generator actually took place in a predetermined sequence specifically adapted for cooking the contents of the user-selected one of the plurality of different PSCCCCDCs and to provide a corresponding quality control output indication.

In accordance with a preferred embodiment of the present invention the computer controller is responsive to a quality control output indication which indicates an operational failure for aborting the cooking. Additionally or alternatively, the computer controller is responsive to a quality control output indication which indicates an operational failure for correcting the cooking.

In accordance with a preferred embodiment of the present invention, the automated, computer-controlled, cooking system for use with user selectable ones of a plurality of different PSCCCCDCs useful in preparing corresponding different food products includes a multiplicity of computer-controlled cooking system units, each cooking system unit including at least a wireless communicator communicating operational details of each cooking operation carried out by the computer-controlled cooking unit and at least one central cooking data monitoring unit communicating wirelessly with the multiplicity of computer-controlled cooking units for at least monitoring operation thereof.

Preferably, the at least one central cooking data monitoring unit is connected to the multiplicity of computer-controlled cooking units by an internet based network.

In accordance with a preferred embodiment of the present invention the at least one central cooking data monitoring unit provides quality control functionality. Additionally or alternatively, the at least one central cooking data monitoring unit provides defect correction functionality. Alternatively or additionally, the at least one central cooking data monitoring unit provides recipe update functionality.

Preferably, the at least one central cooking data monitoring unit enables recipe sharing among users of the multiplicity of computer-controlled cooking units. Additionally or alternatively, the at least one central cooking data monitoring unit provides supply chain monitoring functionality by monitoring supply and usage of specific PSCCCCDCs.

In accordance with a preferred embodiment of the present invention the at least one central cooking data monitoring unit provides counterfeit detection functionality by monitoring supply and usage of specific PSCCCCDCs which are uniquely identified. Additionally or alternatively , the at least one central cooking data monitoring unit provides counterfeit prevention functionality by preventing usage of specific PSCCCCDCs which are uniquely identified as already having been used.

In accordance with a preferred embodiment of the present invention the at least one central cooking data monitoring unit provides malfunction detection functionality by monitoring computerized cooking protocols carried out by the multiplicity of computer-controlled cooking units and matching them to stored computerized cooking protocols assigned to identified PSCCCCDCs whose contents are being cooked. Additionally, the at least one central cooking data monitoring unit provides quality control functionality by monitoring computerized cooking protocols carried out by the multiplicity of computer-controlled cooking units and matching them to stored computerized cooking protocols assigned to identified PSCCCCDCs whose contents are being cooked and preventing dispensing of cooked products in the event of a mismatch.

In accordance with a preferred embodiment of the present invention the at least one central cooking data monitoring unit provides supply and usage monitoring functionality by monitoring supply and usage of specific types of PSCCCCDCs at given times. Additionally or alternatively, the at least one central cooking data monitoring unit provides supply and usage monitoring functionality by monitoring supply and usage of specific types of PSCCCCDCs in given geographical locations. Alternatively or additionally, the at least one central cooking data monitoring unit provides supply and usage monitoring functionality by monitoring supply and usage of specific types of PSCCCCDCs and correlating usage with seasons and geographical locations.

Preferably, the at least one central cooking data monitoring unit provides individual user usage monitoring functionality by monitoring usage of PSCCCCDCs by identified users. Additionally or alternatively, the at least one central cooking data monitoring unit provides individual user calorie consumption monitoring functionality by monitoring usage of identified PSCCCCDCs by identified users.

There is even further provided in accordance with yet another preferred embodiment of the present invention an automated, computer-controlled, cooking system in combination with user selectable ones of a plurality of different pre-sealed computerized cooking containers containing dry contents (PSCCCCDC) useful in preparing corresponding different food products, the system including a microwave radiation generator, a computer-controlled PSCCCCDC support assembly for supporting a user-selected one of the plurality of different PSCCCCDCs during cooking and displacing the user-selected one of the plurality of different PSCCCCDCs during cooking for effecting stirring thereof, a computer-controlled liquid supply subsystem for supplying liquid to the user selected one of the plurality of different PSCCCCDCs and a computer controller operative to control operation of at least the computer-controlled liquid supply subsystem, the computer-controlled stirrer subsystem and the microwave radiation generator in a predetermined sequence corresponding to and specifically adapted for cooking the contents of the user-selected one of the plurality of different PSCCCCDCs, the plurality of different PSCCCCDCs each including a PSCCCCDC body defining a storage and cooking volume and a multi-ingredient, multi-sized and multi-textured dry food precursor located within the PSCCCCDC body, the multi-ingredient, multi-sized and multi-textured dry food precursor including multiple, different freeze-dried food components.

In accordance with a preferred embodiment of the present invention the predetermined sequence defines a computer implementable cooking protocol which includes a sequence of cooking sub-protocols each of which defines at least one parameter relating to operation of the microwave radiation generator and at least one of a parameter relating to operation of the computer-controlled liquid supply subsystem and a parameter relating to operation of the computer-controlled PSCCCCDC support assembly. Alternatively, the predetermined sequence defines a computer implementable cooking protocol which includes a sequence of cooking sub-protocols each of which defines at least one parameter relating to operation of the microwave radiation generator and at least one parameter relating to operation of the computer-controlled liquid supply subsystem.

Preferably, the predetermined sequence defines a computer implementable cooking protocol which includes a sequence of cooking sub-protocols each of which defines at least one parameter relating to operation of the microwave radiation generator and at least one parameter relating to operation of the computer-controlled PSCCCCDC support assembly. Alternatively, the predetermined sequence defines a computer implementable cooking protocol which includes a sequence of cooking sub-protocols each of which defines at least one parameter relating to operation of the microwave radiation generator, at least one parameter relating to operation of the computer-controlled liquid supply subsystem and at least one parameter relating to operation of the computer-controlled PSCCCCDC support assembly.

In accordance with a preferred embodiment of the present invention the computer-controlled PSCCCCDC support assembly is operative to effect stirring of contents of the user selected PSCCCCDC only by moving the PSCCCCDC.

There is still further provided in accordance with yet another preferred embodiment of the present invention an automated, computer-controlled, cooking method for use with user selectable ones of a plurality of different pre-sealed computerized cooking containers containing dry contents (PSCCCCDC) useful in preparing corresponding different food products, the method including supplying liquid to a user-selected one of the plurality of different PSCCCCDCs in accordance with a computer-controlled protocol, producing stirring of the dry contents of the PSCCCCDC together with the liquid in accordance with the computer-controlled protocol by vertical displacement of the user-selected one of the plurality of different PSCCCCDCs, heating of the dry contents of the PSCCCCDC together with the liquid in accordance with the computer-controlled protocol and controlling the supplying, the heating and the stirring in a predetermined sequence governed by the computer-controlled protocol and corresponding to and specifically adapted for cooking the contents of the user-selected one of the plurality of different pre-sealed PSCCCCDCs.

Preferably, the predetermined sequence includes a sequence of cooking sub-protocols each of which defines at least one parameter relating to the heating and at least one parameter related to at least one of the supplying and the stirring.

In accordance with a preferred embodiment of the present invention the stirring is effected only by the vertical displacement of the PSCCCCDC. Additionally or alternatively, the stirring includes displacing the PSCCCCDC in vertical reciprocal motion.

In accordance with a preferred embodiment of the present invention the automated, computer-controlled, cooking method also includes controlling cooking based partially on user inputs received wirelessly and partially on a stored predetermined sequence.

In accordance with a preferred embodiment of the present invention the automated, computer-controlled, cooking method also includes ascertaining whether cooking operations actually took place in a predetermined sequence specifically adapted for cooking the contents of the user-selected one of the plurality of different PSCCCCDCs and providing a corresponding quality control output indication. Additionally, the automated, computer-controlled, cooking method also includes governing cooking in response to the quality control output indication.

In accordance with a preferred embodiment of the present invention the automated, computer-controlled, cooking method also includes aborting cooking in response to the quality control output indication. Alternatively, the automated, computer-controlled, cooking method also includes automatically correcting cooking in response to the quality control output indication.

Preferably, the automated, computer-controlled, cooking method also includes flushing residues of previous supplied liquids into the contents of the user-selected one of the plurality of different PSCCCCDCs. Additionally or alternatively, the automated, computer-controlled, cooking method also includes supplying pressurized air during cooking to lower temperature and pressure within the PSCCCCDC.

In accordance with a preferred embodiment of the present invention the automated, computer-controlled, cooking method also includes supplying liquids to the container during the cooking. Additionally or alternatively, the automated, computer-controlled, cooking method also includes bringing the contents of the container to boiling in the PSCCCCDC.

Preferably, the automated, computer-controlled, cooking method also includes cooling contents of the PSCCCCDC after at least partial cooking thereof.

There is also provided in accordance with still another preferred embodiment of the present invention an automated, computer-controlled, cooking management method for use with user selectable ones of a plurality of different pre-sealed computerized cooking containers containing dry contents (PSCCCCDC) useful in preparing corresponding different food products and a multiplicity of computer-controlled cooking units, each including at least a wireless communicator, the method including communicating operational details of cooking operations carried out by each of the computer-controlled cooking units to at least one remote central cooking data monitoring unit.

In accordance with a preferred embodiment of the present invention the automated, computer-controlled, cooking management method also includes wirelessly communicating computer cooking protocols to at least some of the multiplicity of computer-controlled cooking units. Additionally or alternatively, the automated, computer-controlled, cooking management method also includes correcting cooking operation defects. Preferably, the automated, computer-controlled, cooking management method also includes updating recipes. Additionally or alternatively, the automated, computer-controlled, cooking management method also includes enabling recipe sharing among users of the multiplicity of computer-controlled cooking units.

In accordance with a preferred embodiment of the present invention the automated, computer-controlled, cooking management method also includes monitoring supply and usage of specific PSCCCCDCs. Additionally or alternatively, the automated, computer-controlled, cooking management method also includes: detecting counterfeit PSCCCCDCs by monitoring supply and usage of specific PSCCCCDCs which are uniquely identified. Preferably, the automated, computer-controlled, cooking management method also includes preventing usage of counterfeit PSCCCCDCs by preventing usage of specific PSCCCCDCs which are uniquely identified as already having been used.

In accordance with a preferred embodiment of the present invention the automated, computer-controlled, cooking management method also includes detecting malfunctions by monitoring computerized cooking protocols carried out by the multiplicity of computer-controlled cooking units and matching them to stored computerized cooking protocols assigned to identified PSCCCCDCs whose contents are being cooked.

Preferably, the automated, computer-controlled, cooking management method also includes providing quality control by monitoring computerized cooking protocols carried out by the multiplicity of computer-controlled cooking units, matching the computerized cooking protocols to stored computerized cooking protocols assigned to identified PSCCCCDCs whose contents are being cooked and preventing dispensing of cooked products in the event of a mismatch.

In accordance with a preferred embodiment of the present invention the automated, computer-controlled, cooking management method also includes monitoring supply and usage of specific types of PSCCCCDCs at given times. Additionally or alternatively, the automated, computer-controlled, cooking management method also includes monitoring supply and usage of specific types of PSCCCCDCs in given geographical locations.

Preferably, the automated, computer-controlled, cooking management method also includes monitoring supply and usage of specific types of PSCCCCDCs and correlating usage with seasons and geographical locations. Additionally or alternatively, the automated, computer-controlled, cooking management method also includes monitoring individual user usage of PSCCCCDCs by identified users.

In accordance with a preferred embodiment of the present invention the automated, computer-controlled, cooking management method also includes monitoring individual user calorie consumption by monitoring usage of identified PSCCCCDCs by identified users.

### BRIEF DESCRIPTION OF THE DRAWINGS

The present invention will be understood and appreciated more fully from the following detailed description, taken in conjunction with the drawings in which:

FIG. 1 is a simplified front-facing pictorial illustration of a computer-controlled cooking system constructed and operative in accordance with a preferred embodiment of the present invention;

FIG. 2 is a simplified pictorial illustration of the computer-controlled cooking system of FIG. 1 in a partially disassembled operative orientation;

FIG. 3 is a simplified illustration of the computer-controlled cooking system of FIGS. 1 & 2, showing user-removable portions thereof;

FIG. 4 is a simplified exploded view illustration of the computer-controlled cooking system of FIGS. 1-3;

FIGS. 5A and 5B are simplified partially exploded view illustrations, seen from mutually opposite directions, of a cooking subassembly, forming part of the computer-controlled cooking system of FIG. 4;

FIG. 6 is a simplified exploded view illustration of a base assembly, forming part of the cooking subassembly of FIG. 5;

FIG. 7 is a simplified exploded view illustration of a cover assembly, forming part of the cooking subassembly of FIG. 5;

FIGS. 8A, 8B, 8C and 8D are illustrations of an engagement assembly, forming part of the cover assembly of FIG. 7, wherein FIGS. 8A and 8B are simplified assembled view illustrations, taken in mutually different directions, of the engagement assembly together with part of the cover assembly of FIG. 7, FIG. 8C is a simplified exploded view illustration of part of the engagement assembly and FIG. 8D is a simplified sectional illustration of the engagement assembly taken along lines 8D-8D in FIG. 8B;

FIGS. 9A, 9B, 9C and 9D are, respectively, simplified side facing and downward facing pictorial, side facing pictorial sectional and side planar sectional illustrations of an axle mounted element, forming part of the engagement assembly of FIGS. 8A-8D, FIGS. 9C and 9D being taken along lines 9C-9C and 9D-9D, respectively, in FIG. 9A;

FIGS. 10A, 10B, 10C and 10D are, respectively, a simplified downward facing pictorial, downward facing sectional, side facing pictorial and planar sectional illustrations of a first flanged cylindrical element, forming part of the engagement assembly of FIGS. 8A-8D, FIGS. 10B and 10D being taken along lines 10B-10B and 10D-10D, respectively, in FIG. 10A;

FIGS. 11A, 11B and 11C are, respectively, simplified side facing and top facing pictorial and planar sectional illustrations of a second flanged cylindrical element, forming part of the engagement assembly of FIGS. 8A-8D, FIG. 11C being taken along lines 11C-11C in FIG. 11A;

FIGS. 12A and 12B are respective simplified pictorial and sectional illustrations of a guiding element, forming part of the engagement assembly of FIGS. 8A-8D, FIG. 12B being taken along lines 12B-12B in FIG. 12A;

FIGS. 13A and 13B are simplified respective assembled and exploded view illustrations of a positioning assembly, forming part of the computer-controlled cooking system of FIGS. 1-4;

FIGS. 14A, 14B, 14C are respective simplified first and second pictorial view and exploded view illustrations of a cooking container support assembly, forming part of the positioning assembly of FIG. 13;

FIGS. 15A and 15B are simplified respective assembled and exploded view illustrations of a housing assembly, forming part of the computer-controlled cooking system of FIGS. 1-4;

FIG. 16 is a simplified illustration of a fluid supply system forming part of the computer controlled cooking system of FIGS. 1-4;

FIG. 17 is a simplified electrical functional block diagram of the electrically operated components of the computer-controlled cooking system of FIGS. 1-4;

FIG. 18 is a simplified network diagram of a cloud-based network interconnecting a multiplicity of computer-controlled cooking systems of the type illustrated in FIGS. 1-4;

FIGS. 19A, 19B, 19C and 19D are simplified illustrations of various stages of pre-cooking operation of the computer-controlled cooking system of FIGS. 1-4;

FIGS. 20A and 20B are simplified illustrations of various stages of cooking operation of the computer-controlled cooking system of FIGS. 1-4; and

FIGS. 21A, 21B and 21C are simplified illustrations of various stages of post-cooking operation of the computer-controlled cooking system of FIG. 1-4.

### DETAILED DESCRIPTION OF A PREFERRED EMBODIMENT

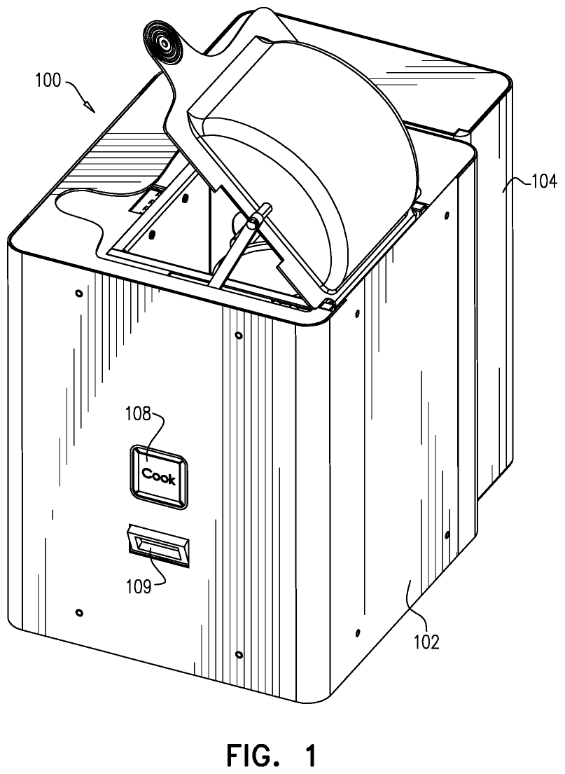

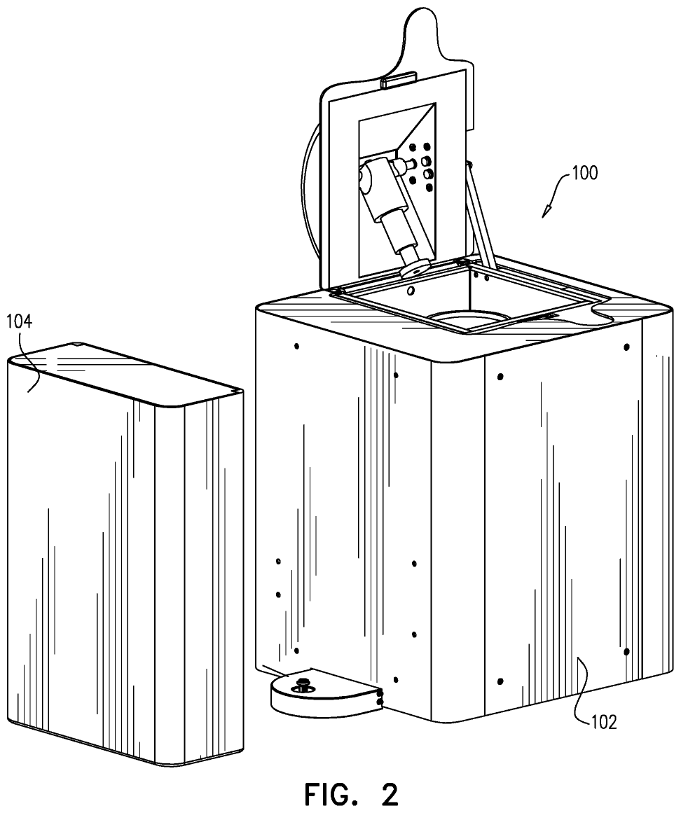

Reference is now made to FIGS. 1-3, which are simplified illustrations of a computer-controlled cooking system 100, constructed and operative in accordance with a preferred embodiment of the present invention.

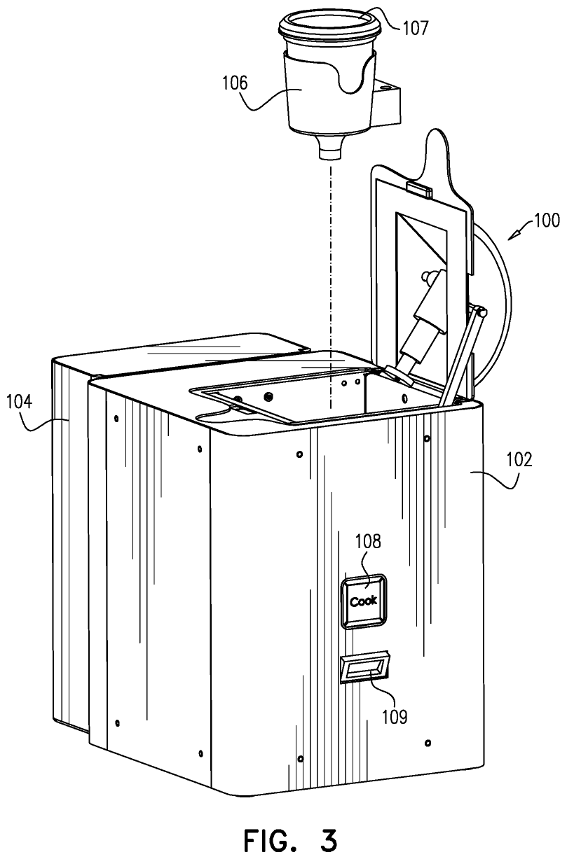

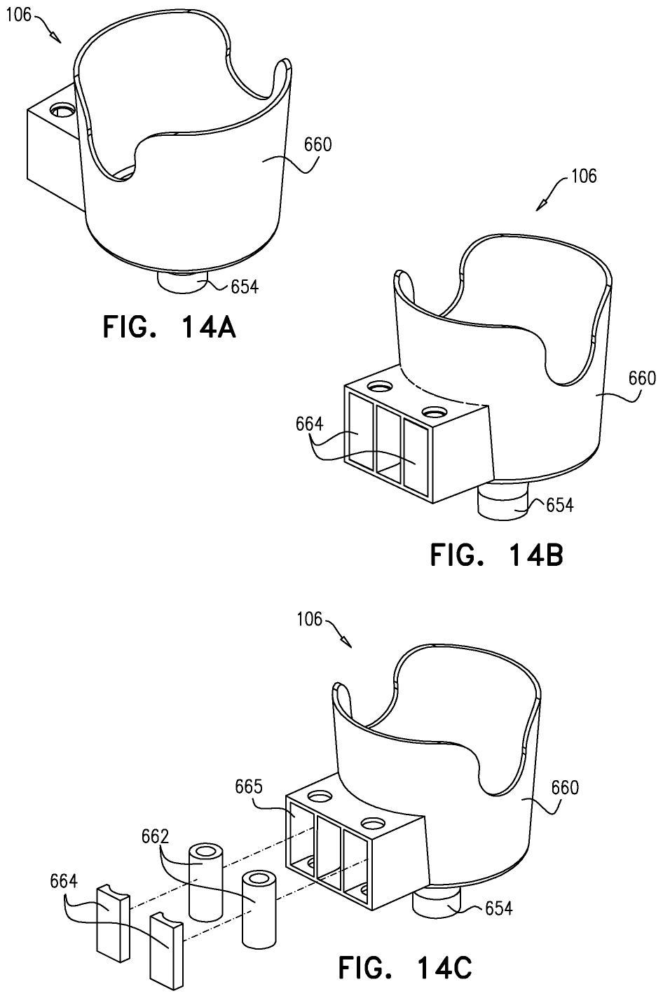

As seen in FIGS. 1 & 2, the computer-controlled cooking system 100 comprises a cooking assembly 102 and a cooking liquid container 104, which is removably mounted onto the cooking assembly 102. FIG. 3 shows a cooking container support assembly 106, which is normally user removable from the remainder of the cooking assembly 102 for cleaning, suitable for supporting a cooking container 107. Preferred cooking containers are pre-sealed computerized cooking containers containing dried contents (PSCCCCDC), shown and described in the aforesaid PCT Patent Application PCT/IL2017/050195, entitled AUTOMATED, COMPUTER-CONTROLLED COOKING SYSTEM AND METHOD, filed Feb. 15, 2017, the contents of which are hereby incorporated by reference, particularly at FIGS. 13A and 13B thereof and in the accompanying description.

In a preferred embodiment of the present invention the cooking container 107 includes a container body defining a storage and cooking volume and a multi-ingredient, multi-sized and multi-textured dry food precursor located within the container body, where the multi-ingredient, multi-sized and multi-textured dry food precursor preferably includes multiple, different freeze-dried food components.

In accordance with a preferred embodiment of the present invention, the cooking assembly includes an operation initiation button 108 and a bar code reader 109.

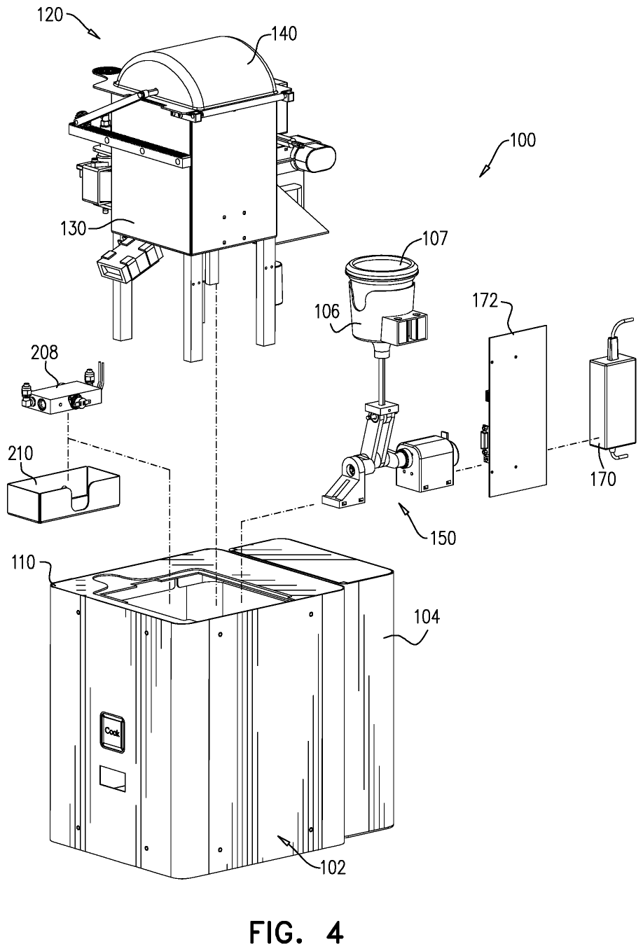

Reference is now made to FIG. 4, which is a simplified exploded view illustration of the computer-controlled cooking system of FIGS. 1-3.

As seen in FIG. 4, the computer-controlled cooking system 100, and more specifically the cooking assembly 102, includes a housing assembly 110 in which is disposed a cooking subassembly 120 including a base assembly 130 and a cover assembly 140. A computer-controlled stirrer subsystem, in the form of a positioning assembly 150, is also disposed within housing assembly 110 for selectable positioning and displacement of container support assembly 106.

An electrical power supply 170 and at least one electrical circuit board 172 are preferably mounted within housing assembly 110 outside of cooking sub-assembly 120, preferably by mounting onto the inside of an outer wall of housing assembly 110 via mounting brackets (not shown).

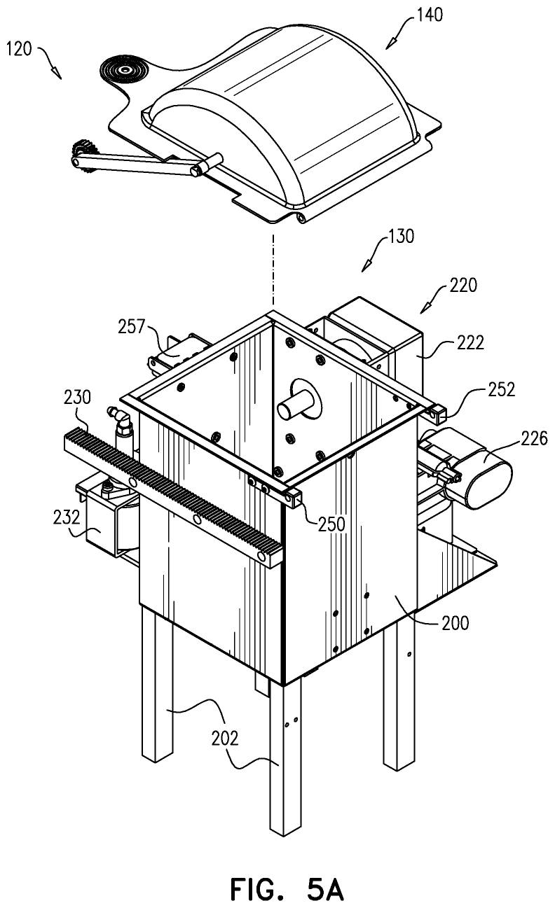

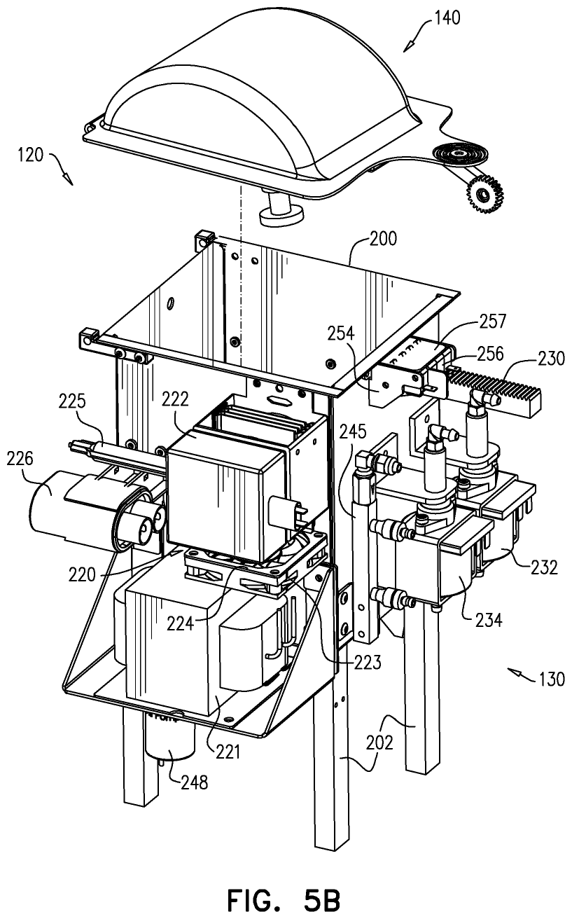

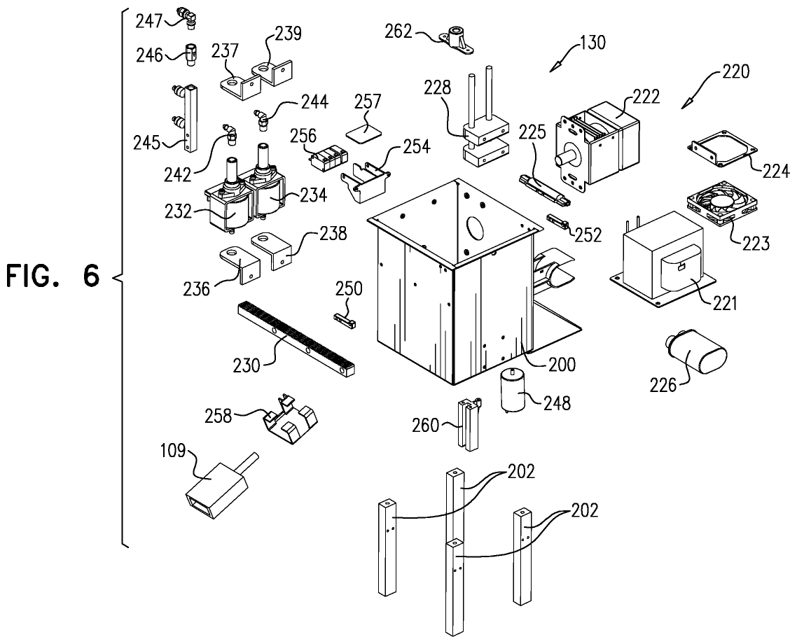

Reference is now made additionally to FIGS. 5A and 5B, which are simplified exploded view illustrations of cooking subassembly 120 forming part of the computer-controlled cooking system 100, and FIG. 6, which is a simplified exploded view illustration of base assembly 130 forming part of the cooking subassembly 120.

As seen more clearly in FIGS. 5A, 5B and 6, base assembly 130 preferably includes a fixed outer enclosure 200, which is supported on vertical supports 202. An electric water heater 208 (FIG. 4) is preferably mounted within a mounting support 210 (FIG. 4) onto fixed outer enclosure 200 by means of connectors (not shown). Water heater 208 is preferably constructed and operative as described in U.S. patent application Ser. No. 14/942,149 entitled APPARATUS FOR RAPID HEATING OF LIQUIDS, filed Nov. 16, 2015, published as U.S. Patent Publication U.S. 2017/0138632, the disclosure of which is hereby incorporated by reference.

A microwave energy generating assembly 220 is mounted onto a side of the fixed outer enclosure 200. Microwave energy generating assembly 220 includes a power supply 221, a magnetron 222, such as a PANASONIC INVERTER MICROWAVE OVEN MAGNATRON 2M261-M39 641W and a fan 223, mounted on a bracket 224, for directing an air flow through the magnetron 222. Associated with magnetron 222 are preferably a fuse 225, a capacitor 226 and a diode (not shown).

A container support guiding assembly 228 is fixed to the inside of the fixed outer enclosure 200 for a purpose that is described hereinbelow with reference to FIGS. 14A-14C. A linear gear track 230 is preferably mounted onto an outer side of the fixed outer enclosure 200 opposite from generator 220.

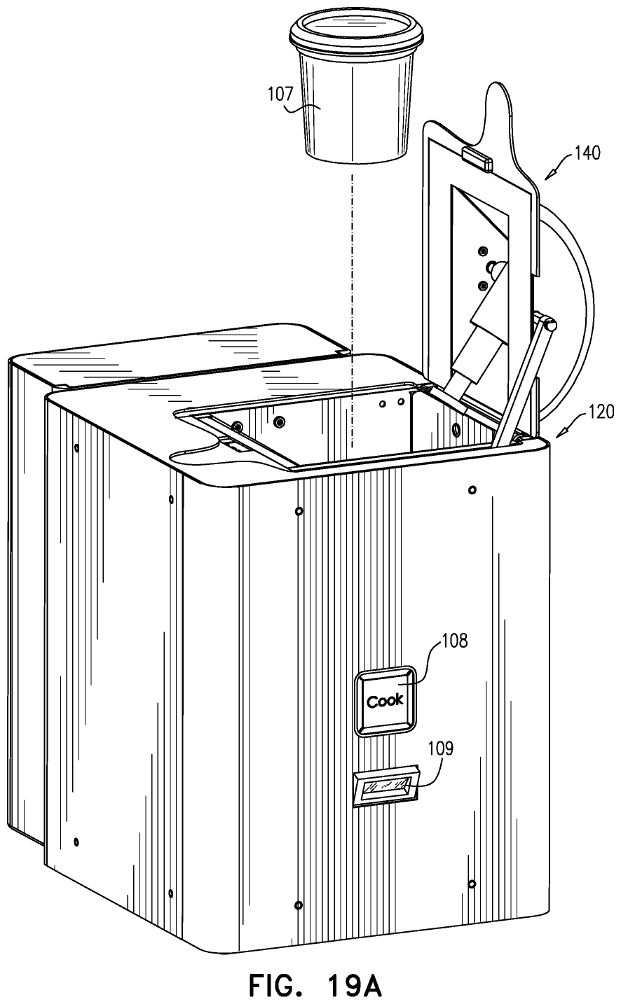

Associated with base assembly 130 is a computer-controlled fluid supply subsystem which is described hereinbelow in detail with reference to FIG. 16. For the sake of clarity, most of the computer-controlled liquid supply system is not shown in FIG. 6, with the exception of a cold water pump 232 and a hot water pump 234, mounted, via respective sets of brackets 236 & 237, and 238 & 239, onto an outside surface of fixed outer enclosure 200, which are provided with respective fluid outlet connectors 242 and 244. A manifold 245 is preferably mounted onto an outer side of the fixed outer enclosure 200 via a bracket (not shown) and is provided with a one-way valve 246 and a fluid connector 247. An air pump 248 is disposed preferably under fixed outer enclosure 200.

A pair of cover pivot axle mounting brackets 250 and 252 are also mounted onto an outside surface of fixed outer enclosure 200.

A bracket 254 supports a plurality of electrical switches 256 which sense closure of cover 140 and are connected to magnetron 222 such that the magnetron is inoperable when the cover 140 is not closed. Plurality of electrical switches 256 are covered by a switch cover 257 so they are hidden from view when cover 140 is open.

Bar code reader 109 (FIG. 1) is preferably mounted to the bottom of fixed outer enclosure 200 via a bar code reader bracket 258.

A track member 260 is preferably mounted on an outer bottom surface of fixed outer enclosure 200 and a linear bearing 262 on an inner bottom surface of fixed outer enclosure 200. Both of these elements are useful in guiding operation of positioning assembly 150.

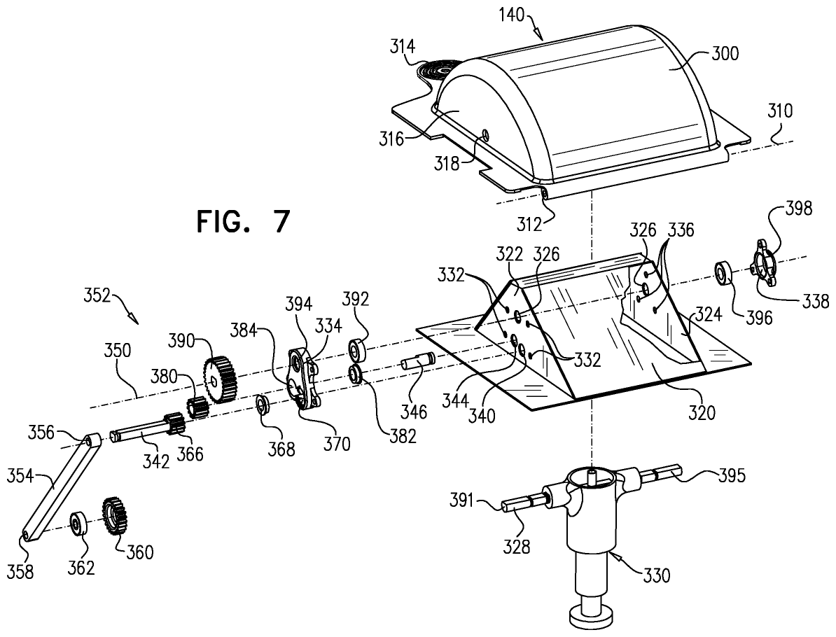

Reference is now made to FIG. 7, which illustrates cover assembly 140. As seen in FIG. 7, cover assembly 140 includes a pivotable cover portion 300, which is arranged to pivot about a pivot axis 310, preferably defined by an axle 312 which engages mounting brackets 250 and 252 (FIG. 6). Cover portion 300 also includes a manually engageable handle portion 314 and an apertured side wall portion 316 having an aperture 318.

Preferably fixedly attached to cover portion 300 and located interiorly thereof is an engagement assembly support frame element 320 (shown in a partially cut away view). Engagement assembly support frame element 320 is preferably a generally side to side symmetric element which includes mutually facing and mutually aligned apertured side panels 322 and 324, each of which is preferably formed with an axle accommodating aperture 326 for accommodating a pivot axle 328 of an engagement assembly 330. Apertured side panel 322 is additionally formed with four apertures 332 for exterior mounting onto panel 322 of a gear and axle mounting bracket 334 via fasteners (not shown), while aperture side panel 324 is additionally formed with three apertures 336 for exterior mounting onto panel 324 of an axle mounting bracket 338 via fasteners (not shown). Apertured side panel 322 is formed with a lever pin accommodating aperture 340 for accommodating a lever pin 342 and an intermediate gear pin mounting aperture 344 for accommodating an intermediate gear pin 346.

Pivot axle 328 of engagement assembly 330 is selectably pivoted about an engagement assembly pivot axis 350, defined by apertures 326 formed in engagement assembly support frame element 320, by an engagement axle rotating assembly 352. Engagement axle rotating assembly 352 includes an elongate lever element 354 having mounting apertures 356 and 358 located at upper and lower ends thereof, respectively.

A gear 360 is rotatably mounted via a bearing 362 onto elongate lever element 354 at aperture 358 and is arranged to engage the toothed surface of linear gear track 230 (FIG. 6). Lever pin 342 is fixedly mounted onto elongate lever element 354 at aperture 356 and rotatably extends through aperture 318 in apertured side wall portion 316 of cover portion 300. A gear 366 is fixedly mounted onto lever pin 342 interiorly of cover portion 300 and is rotatably mounted with respect to mounting bracket 334 via a bearing 368, seated in a recess 370 in mounting bracket 334. Gear 366 engages an intermediate gear 380, which is rotatably mounted onto intermediate gear pin 346 with respect to mounting bracket 334 via a bearing 382 seated in a recess 384 in mounting bracket 334 and engages a main gear 390, which is fixedly mounted onto an end 391 of pivot axle 328. Pivot axle 328 is rotatably mounted at its end 391 with respect to mounting bracket 334 via a bearing 392 seated in a recess 394 in mounting bracket 334 and is rotatably mounted at an opposite end 395 thereof with respect to mounting bracket 338 via a bearing 396 seated in a recess 398 in mounting bracket 338.

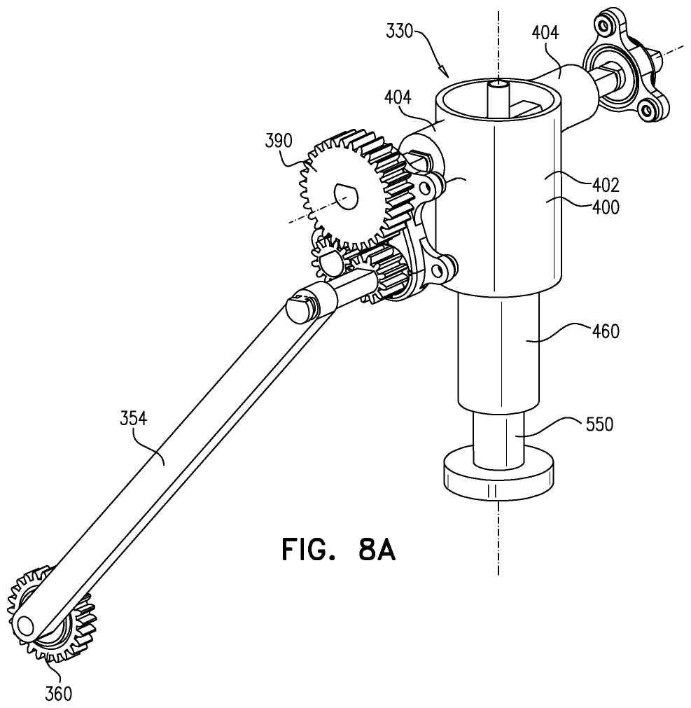

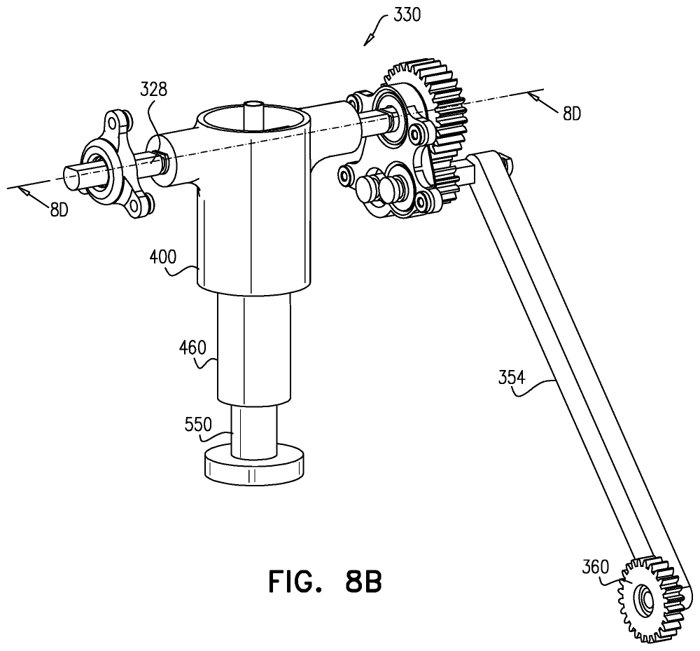

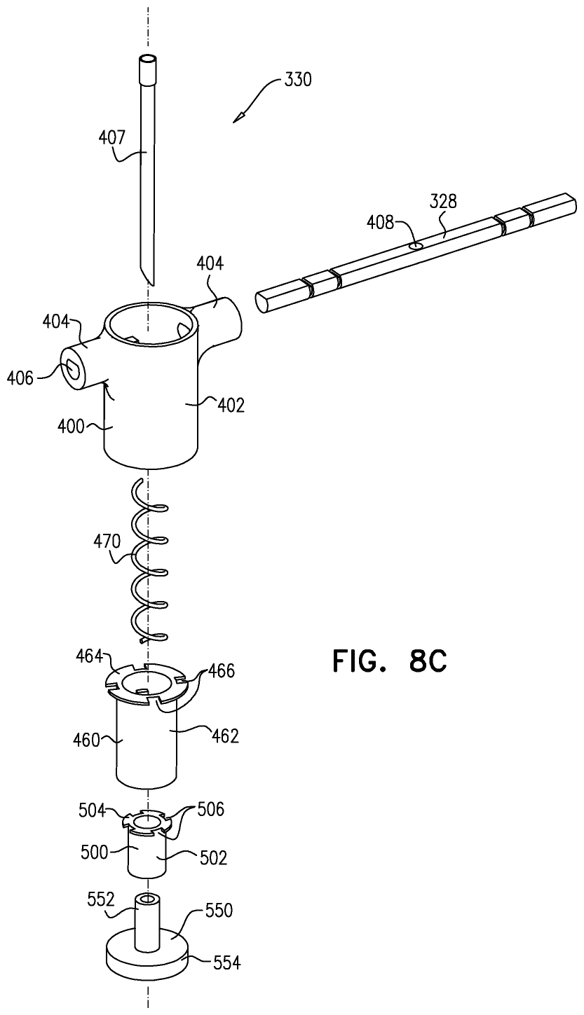

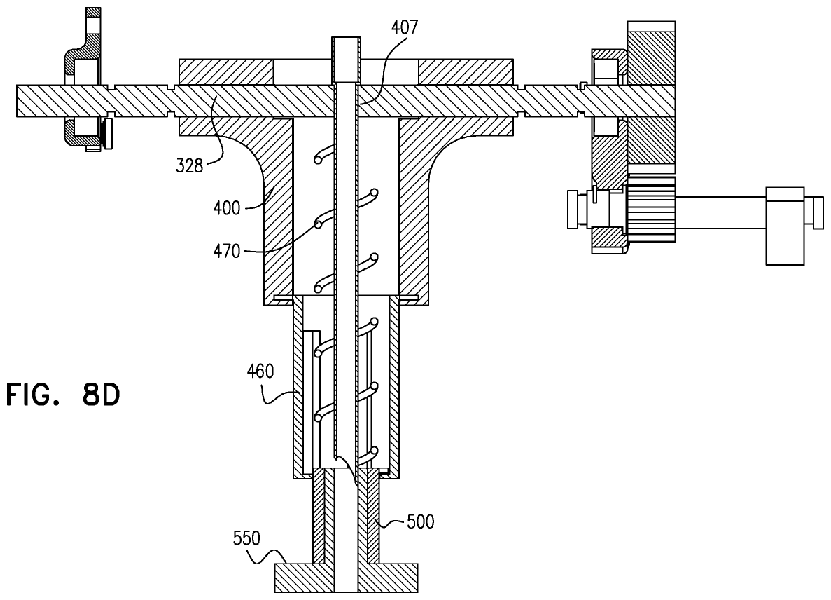

Reference is now made to FIGS. 8A, 8B, 8C and 8D, which are illustrations of engagement assembly 330, forming part of the cover assembly of FIG. 7, wherein FIGS. 8A and 8B are simplified assembled view illustrations, taken in mutually different directions, of the engagement assembly together with part of the cover assembly of FIG. 7, FIG. 8C is a simplified exploded view illustration of the engagement assembly and FIG. 8D is a simplified sectional illustration of the engagement assembly taken along lines 8D-8D in FIG. 8B.

As seen in FIGS. 8A-8D, engagement assembly 330 includes an axle mounted element 400 which is fixedly mounted onto pivot axle 328. Axle mounted element 400 includes a main, generally cylindrical portion 402 and a pair of arm portions 404 extending outwardly from cylindrical portion 402. Arm portions 404 are preferably formed with non-circular bores 406 for accommodating a non-circular cross section of pivot axle 328 in a fixed mounting relationship. A fluid feeding and PSCCCCDC piercing tube 407 extends through a transverse opening 408 in pivot axle 328 and through cylindrical portion 402.

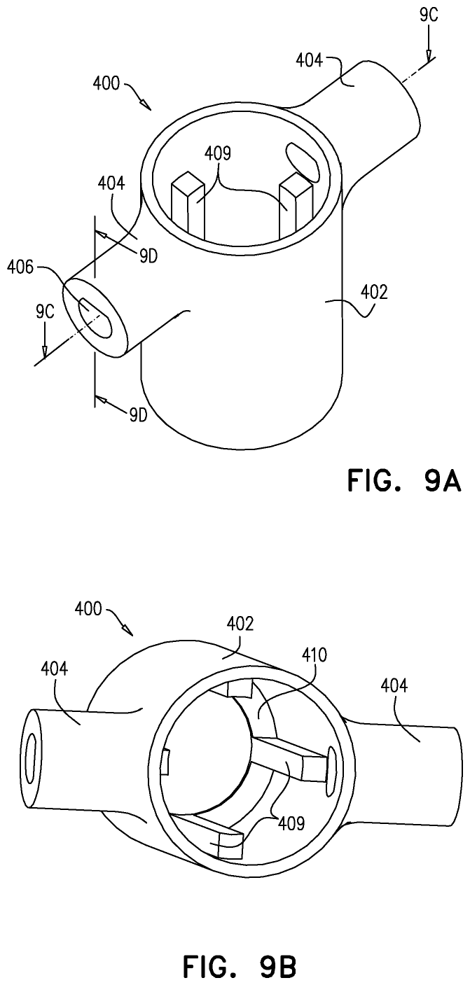

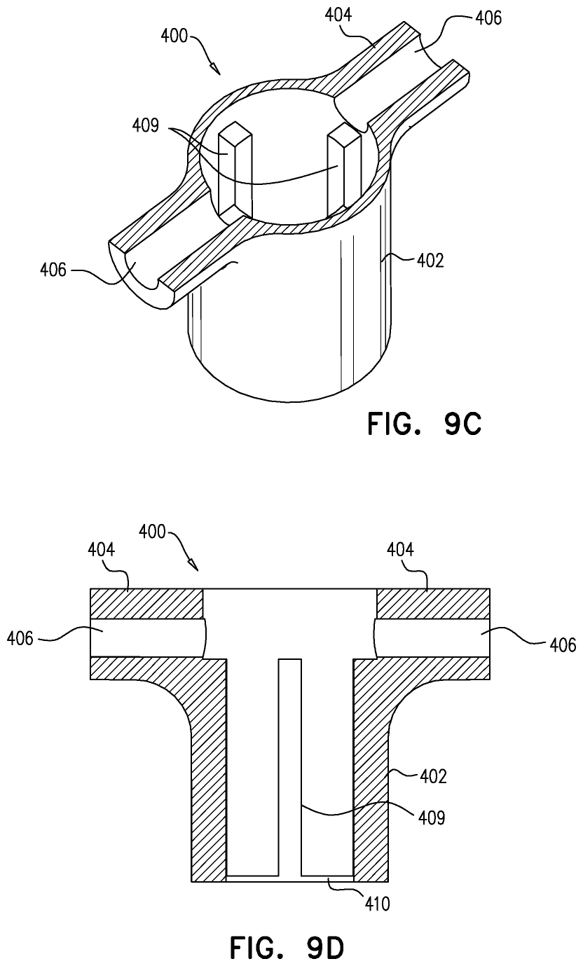

As seen more clearly in FIGS. 9A-9D, axle mounted element 400 also includes four equally spaced runners 409 extending from an inner facing rim 410.

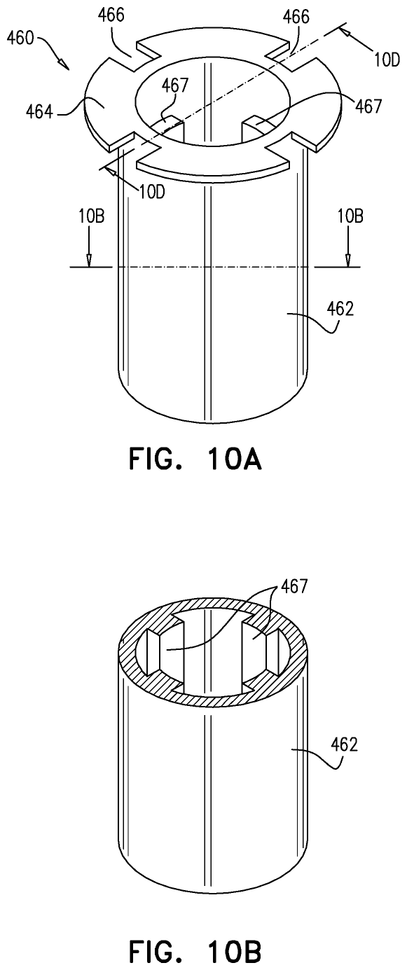

Partially disposed within axle mounted element 400 is a first flanged cylindrical element 460. As seen more clearly in FIGS. 10A-10D first flanged cylindrical element 460 includes a cylindrical body portion 462 and a flange 464 having four equally spaced notches 466 formed therein which are preferably rotationally restricted by runners 409 of axle mounted element 400 (FIGS. 9A-9D) to prevent rotation of first flanged cylindrical element 460 with respect to axle mounted element 400. First flanged cylindrical element 460 further includes four equally spaced runners 467 extending from an inner facing rim 468. It is appreciated that disengagement of first flanged cylindrical element 460 from axle mounted element 400 is prevented by engagement of flange 464 of first flanged cylindrical element 460 with inner facing rim 410 of axle mounted element 400.

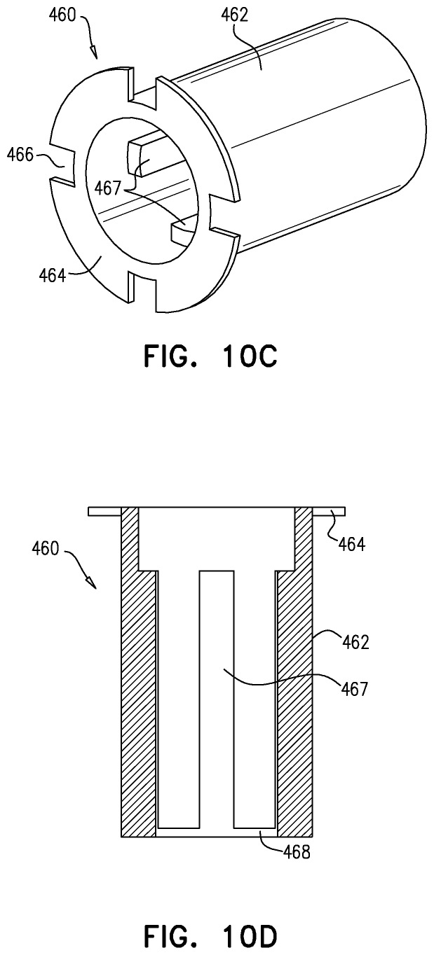

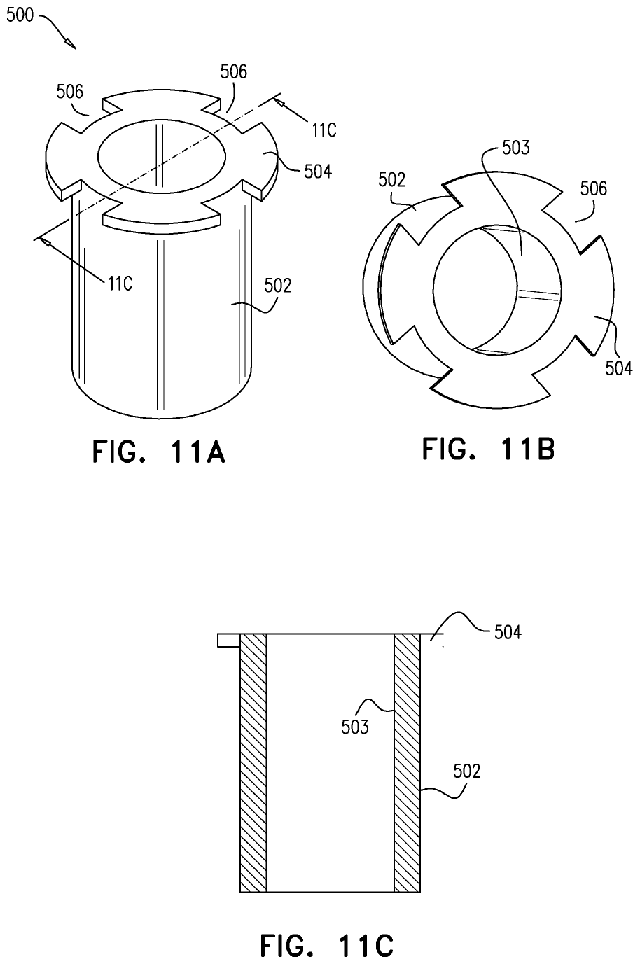

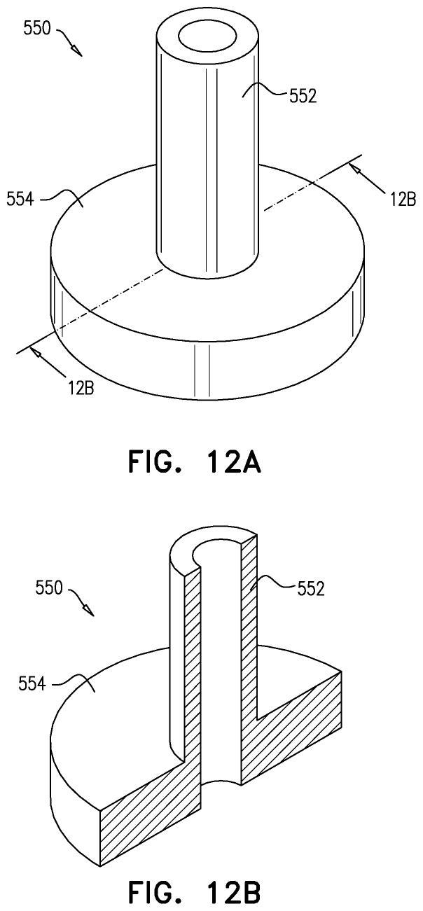

Partially disposed within first flanged cylindrical element 460 and spring loaded therewithin by a coil spring 470 is a second flanged cylindrical element 500. As seen more clearly in FIGS. 11A-11C, second flanged cylindrical element 500 includes a cylindrical body portion 502 having an inner surface 503 and a flange 504 having four equally spaced notches 506 formed therein which are preferably rotationally restricted by the runners 467 of first flanged cylindrical element 460 (FIGS. 10A-10D) to prevent rotation of second flanged cylindrical element 500 with respect to first flanged cylindrical element 460. It is appreciated that disengagement of second flanged cylindrical element 500 from first flanged cylindrical element 460 is prevented by engagement of flange 504 of second flanged cylindrical element 500 with inner facing rim 468 of first flanged cylindrical element 460.

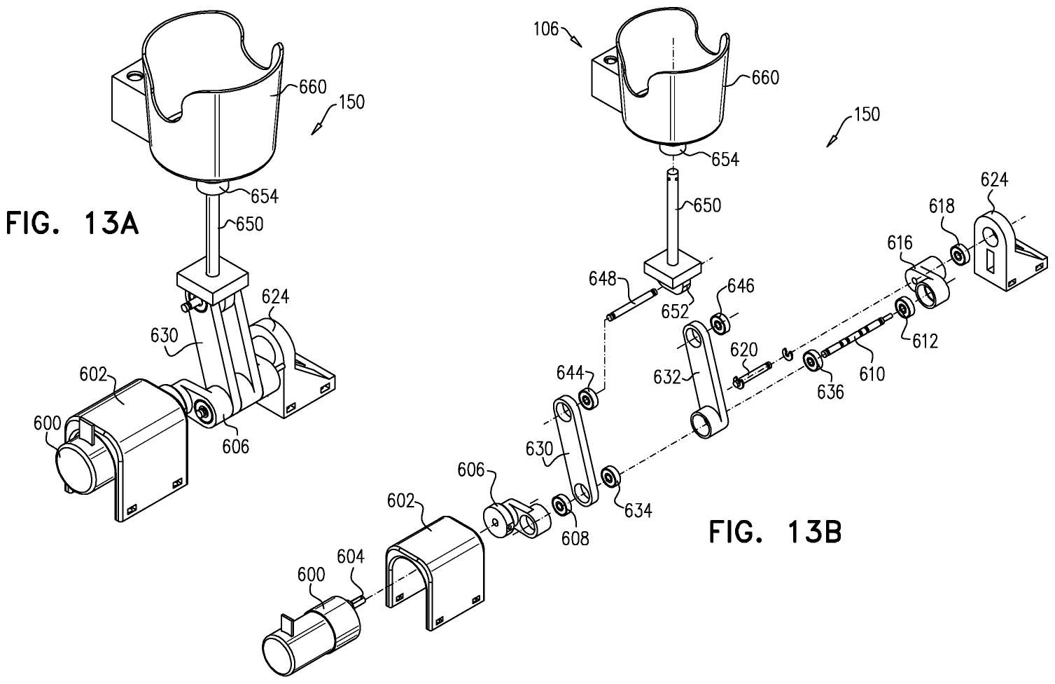

Partially disposed within second flanged cylindrical element 500 is a guiding element 550. As seen more clearly in FIGS. 12A-12B guiding element 550 includes a cylindrical body portion 552 and a bottom flange 554. The bottom flange 554 of guiding element 550 preferably keeps piercing tube 407 perpendicular to the top cover surface of cooking container 107 during operation. Guiding element 550 is preferably fixed to second flanged cylindrical element 500 by press-fit engagement of cylindrical body portion 552 of guiding element 550 with inner surface 503 of second flanged cylindrical element 500.

Reference is now made to FIGS. 13A and 13B, which are simplified assembled and exploded view illustrations of positioning assembly 150, forming part of the computer-controlled cooking system 100 of FIG. 4. As seen in FIGS. 13A and 13B, positioning assembly 150 comprises a rotary drive DC stepper motor 600, which is mounted in a motor housing 602 and has an output shaft 604. Mounted onto output shaft 604 for rotation together therewith is a first pivot element 606. Rotatably mounted onto first pivot element 606 by means of bearing 608 is a first end of a first pivot axle 610. First pivot axle 610 is rotatably mounted at a second end thereof via bearings 612 onto a second pivot element 616, which is rotatably mounted via a bearing 618 and a shaft 620 onto a static first pivot axle support 624.

First and second pivot arms 630 and 632 are rotatably mounted at respective first ends thereof, by respective bearings 634 and 636, onto first pivot axle 610. First and second pivot arms 630 and 632 are rotatably mounted at respective second ends thereof, by respective bearings 644 and 646, onto a second pivot axle 648. A displacer shaft 650 is rotatably mounted, at a first lower end thereof having an aperture 652 formed therein, onto second pivot axle 648 and is fixedly and removably mounted at a second upper end thereof to a base portion 654 of cooking container support assembly 106, which in turn supports a main portion 660 of cooking container support assembly 106.

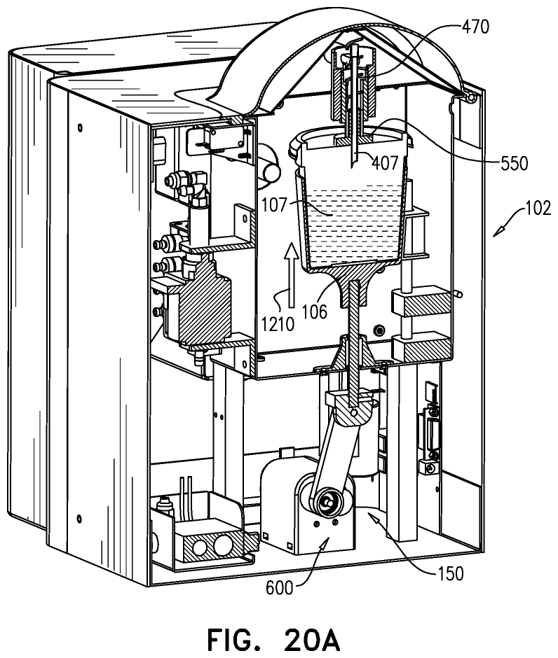

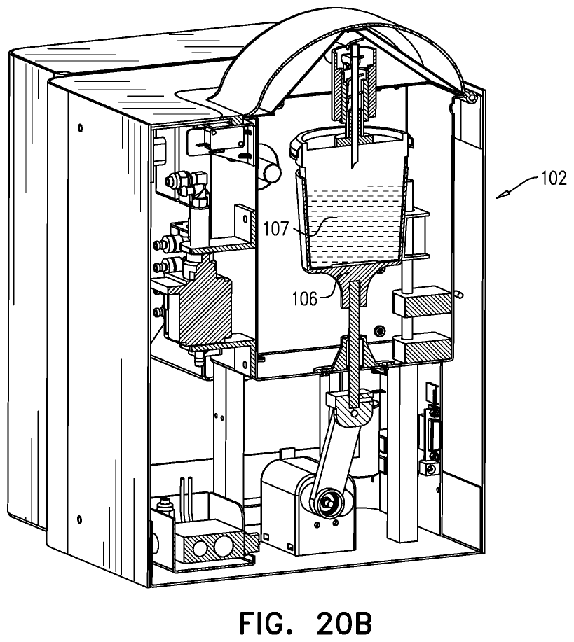

As described hereinbelow, with reference to FIGS. 20A and 20B, positioning assembly 150 is operative, inter alia, to stir the contents of cooking container 107 by moving the cooking container 107 in a vertical direction, by repeated raising and lowering thereof.

Reference is now made to FIGS. 14A, 14B and 14C which are, respectively, simplified first and second pictorial illustrations and an exploded view illustration of cooking container support assembly 106, forming part of the positioning assembly of FIG. 13. As seen in FIGS. 14A-14C cooking container support assembly 106 includes base portion 654, which supports main portion 660, which in turn is preferably used to hold cooking container 107 during operation. Cooking container support assembly 106 further includes a pair of linear bearings 662 and linear bearing covers 664 which retain linear bearings in a linear bearing bracket 665, which forms a part of main portion 660. Linear bearings 662 slide on container support guiding assembly 228 (FIG. 6).

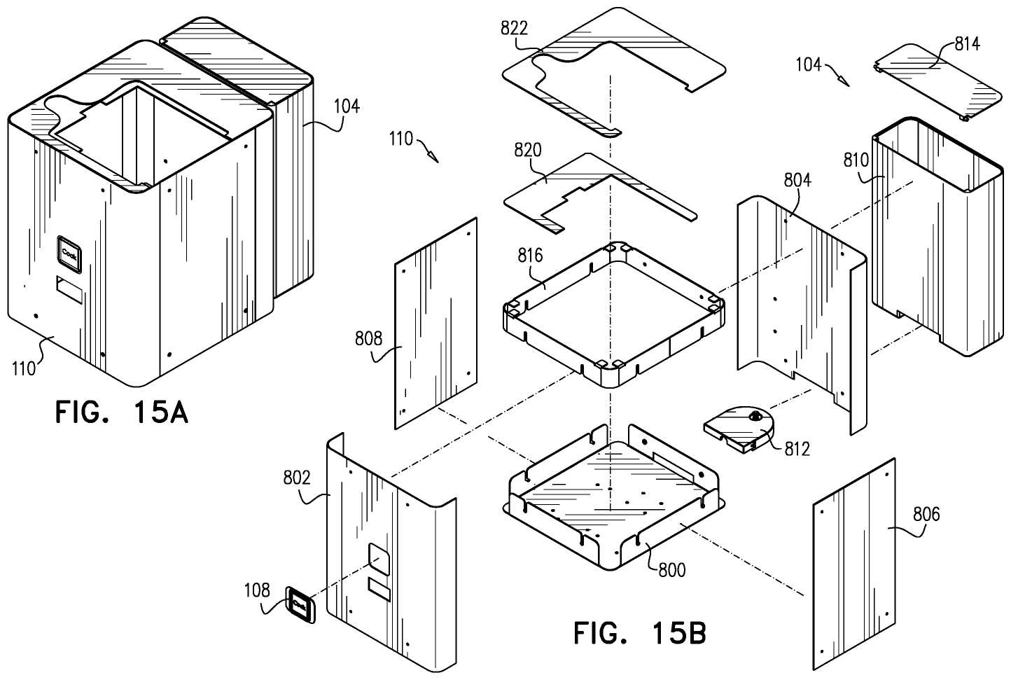

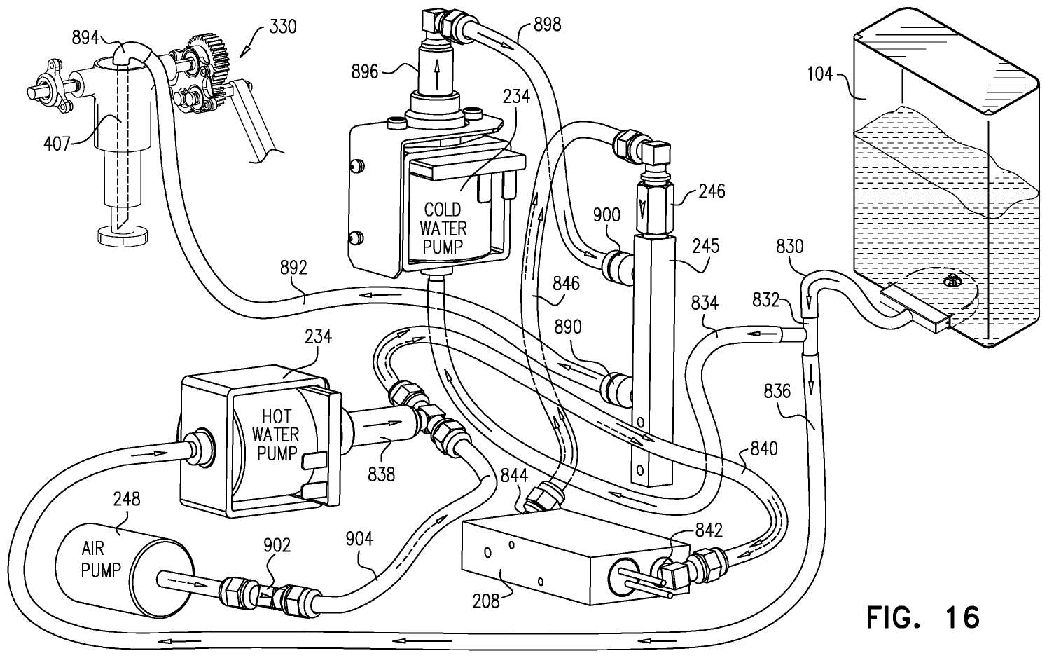

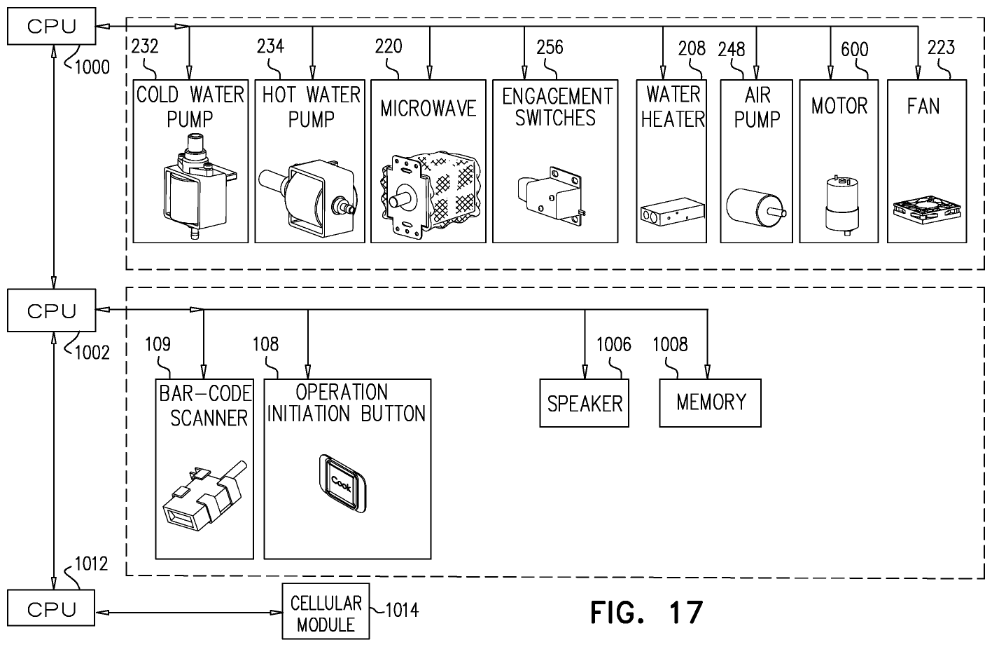

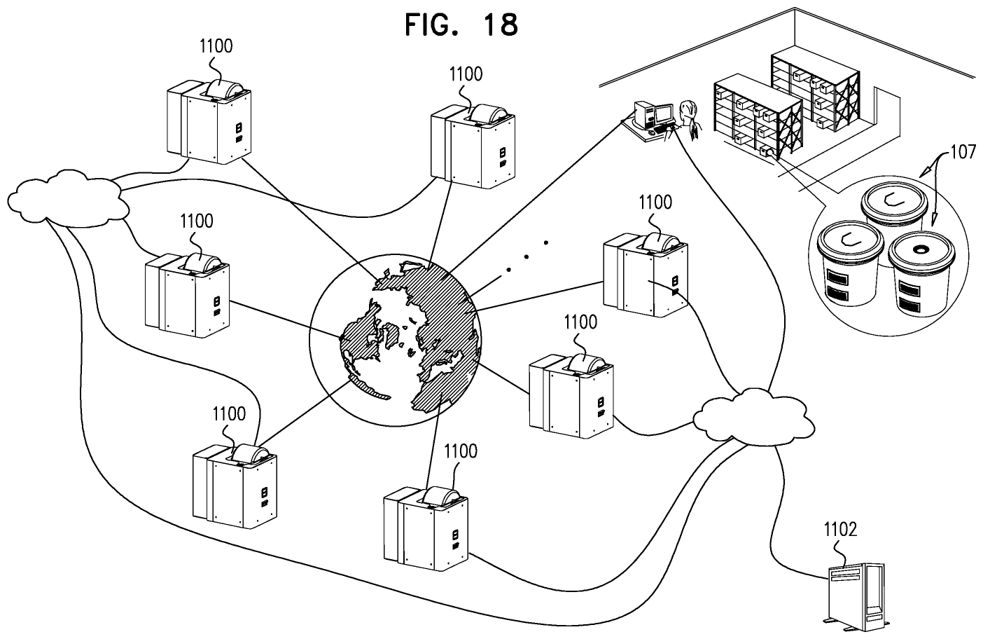

Reference is now made to FIGS. 15A and 15B, which are simplified assembled and exploded view illustrations of cooking liquid container 104 and housing assembly 110, forming part of the computer-controlled cooking system 100 of FIG. 4. As seen in FIGS. 15A and 15B, housing assembly 110 preferably comprises a base 800, onto which are mounted a front panel 802, a back panel 804 and a pair of side panels 806 and 808. Cooking liquid container 104 preferably includes a cooking liquid tank enclosure 810, which is removably mounted onto base 800 via a support element 812 and is provided with a removable top 814. An upper connector 816 is mounted onto front panel 802, back panel 804 and side panels 806 and 808 and supports a pair of top panels 820 and 822. Panel 820 shields much of the exterior of cooking sub-assembly 120 from view when cover 140 is open and panel 822 is configured such that when cover 140 is closed, a top surface of manually engageable handle portion 314 is flush with a top surface of panel 822.

Reference is now made to FIG. 16, which is a simplified respective pictorial and partial exploded view illustrations of fluid supply subsystem, including a liquid supply subsystem and air pump 248 (FIG. 6) connection. As noted above, fluid supply subsystem forms part of the computer-controlled cooking system of FIGS. 1-6 but is only partially shown in FIGS. 1-6.

As seen in FIG. 16, the fluid supply subsystem comprises a main liquid supply tube 830, which communicates with the interior of a liquid container, such as cooking liquid container 104, and is coupled, such as via a T-connector 832, with a pair of liquid supply tubes 834 and 836.

Liquid supply tube 836 supplies water to hot water pump 234 (FIG. 6), which supplies pressurized water, via a one-way valve 838 and a pressurized water tube 840, to an inlet 842 of water heater 208 (FIG. 4). Pressurized heated water or steam is supplied from an outlet 844 of water heater 208, via a heated water/steam tube 846 and one-way valve 246, to manifold 245. Pressurized heated water or steam is supplied from an outlet connector 890 of manifold 245, via a pressurized heated water/steam tube 892, to a fluid inlet connector 894 and piercing tube 407 of engagement assembly 330. The supply of steam is preferably useful for flushing of the various liquid supply passageways between sequential cooking operations.

Liquid supply tube 834 supplies water to cold water pump 232 (FIG. 6), which supplies pressurized water, via a one-way valve 896 and a pressurized water tube 898, to an inlet 900 of manifold 245. Pressurized cold water is supplied from outlet connector 890 of manifold 245 via pressurized tube 892 to fluid inlet connector 894 and piercing tube 407 of engagement assembly 330.

Air pump 248 (FIG. 6) supplies pressurized air, via a one-way valve 902, a pressurized air tube 904 and tube 840, to inlet 842 of water heater 208. Pressurized heated air or steam is supplied from outlet 844 of water heater 208, via heated water/steam tube 846 and one-way valve 252, to manifold 245 and via outlet connector 890 of manifold 245, via pressurized tube 892, to fluid inlet connector 894 and piercing tube 407 of engagement assembly 330.

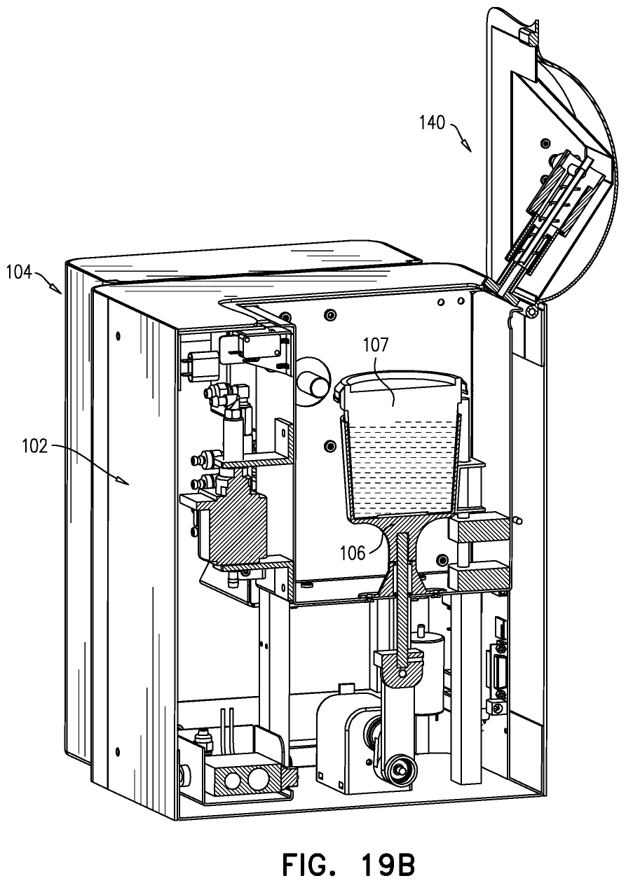

It is a particular feature of the present invention that, as will be described hereinbelow in detail with reference to FIG. 17, the hot water pump 234, the cold water pump 232, the air pump 248 and the water heater 208 are all computer controlled and operated at predetermined times suitable for cooking predetermined meals. Typically, the water heater 208 is operated continuously.

Reference is now made to FIG. 17, which is a simplified electrical functional block diagram of the electrically operated components of the computer-controlled cooking system of FIGS. 1-16. In the illustrated embodiment, a CPU 1000 preferably is in bi-directional data communication with and controls the operation of cold water pump 232, hot water pump 234, microwave radiation generator 220, engagement switches 256, water heater 208, air pump 248, motor 600 and fan 223.

An additional CPU 1002 preferably is in bi-directional data communication with CPU 1000 and with operation initiation button 108, bar-code reader 109, a speaker 1006 and a memory 1008, which preferably stores at least computerized cooking recipes.

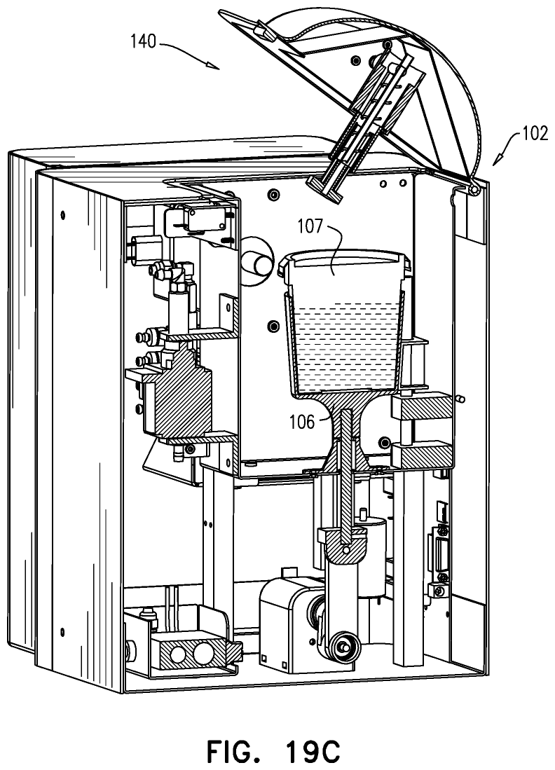

A further CPU 1012 preferably is in bi-directional data communication with a wireless communication module, such as a cellular communications module 1014, and preferably provides a network connection as described hereinbelow with reference to FIG. 18.

It is appreciated that the computer-controlled cooking system 100 also includes a cooking instructions input interface for receiving PSCCCCDC specific cooking instructions, which may be embodied, inter alia, in bar-code reader 109 reading cooking recipes encoded in the bar-code, cellular communications module 1014 receiving cooking recipes from a remote device or from the internet or any suitable interface which retrieves stored cooking recipes from memory 1008. In another embodiment, computer-controlled cooking system 100 may receive a cooking instructions input via a link to either a web address or to memory 1008 embedded in a bar-code read by bar-code reader 109. Additionally, computer-controlled cooking system 100 may include a user interface, such as a keyboard, a mouse, a voice input device or any other suitable input device for providing a user input cooking recipe or a user modification to an existing cooking recipe.

Reference is now made to FIG. 18, which is a simplified network diagram of a cloud-based network interconnecting a multiplicity of computer-controlled cooking systems of the type illustrated in FIGS. 1-16. As seen in FIG. 18, a multiplicity of computer-controlled cooking systems 100 of the type illustrated in FIGS. 1-16, here each designated by reference numeral 1100, are connected in a virtual network, preferably using the internet via a cellular communications module (not shown) which is incorporated into each such computer-controlled cooking system 100, to a cloud server 1102 or any other suitable computer system. The various computer-controlled cooking systems 1100 may also communicate directly between themselves and with other entities, such as websites of suppliers of cooking containers 107, via suitable web applications.

The network preferably enables new and modified recipes to be distributed to the various computer-controlled cooking systems 1100 by cloud server 1102 and to be shared among the various computer-controlled cooking systems 1100. Users may also use the network to input various user inputs to the various computer-controlled cooking systems 1100 by means of applications which reside on conventional mobile devices, such as smartphones. Alternatively, user input for modifying or selecting computer controlled cooking may be input to various computer-controlled cooking systems 1100 via bar codes which may be user generated and read by bar code reader 109 incorporated within each of the computer-controlled cooking systems 1100.

The network preferably enables tracking of purchase and use of specific cooking containers 107 to be tracked by the cloud server, in order to ensure that sufficient supplies of specific types of cooking containers 107 are made available to consumers. Preferably, cooking/dispensing of each cooking container 107 is reported automatically by each of the various computer-controlled cooking systems 1100 to the cloud server 1102 so that trends in usage of specific types of cooking containers 107 can be analyzed and predicted and quality control functionality may be provided. Accordingly, difficulties in usage of computer-controlled cooking systems 1100 can also be automatically monitored, tracked and corrected.

The network also enables consumption and calorie content of cooked cooking containers 107 to be monitored for each computer-controlled cooking system 1100. The network and particularly the individual coding of each cooking container 107 enables counterfeiting of cooking containers 107 to be detected and counteracted.

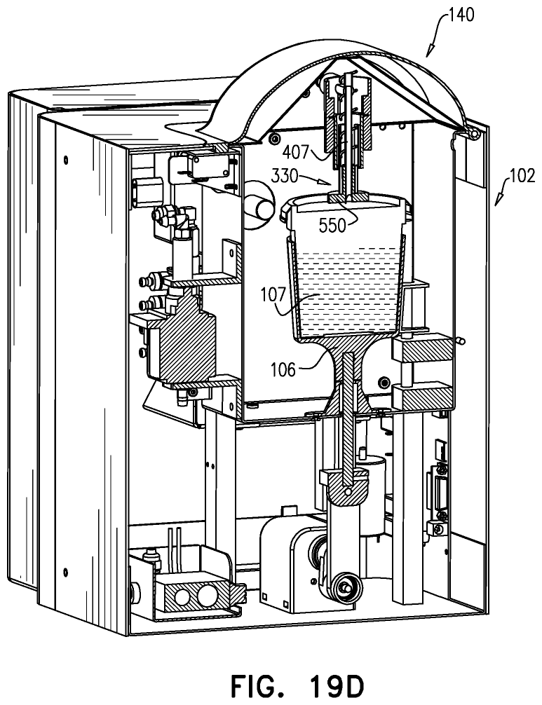

Reference is now made to FIGS. 19A, 19B, 19C and 19D, which are simplified illustrations of various stages of pre-cooking operation of the computer-controlled cooking system of FIG. 1-16.

As seen in FIG. 19A, a cooking container 107, preferably a pre-sealed computerized cooking container containing dry contents (PSCCCCDC), is about to be inserted into operative engagement with cooking assembly 102. The cooking assembly 102 is seen with its cover assembly 140 in a fully raised operative orientation. Two alternative preferred embodiments of cooking container 107 are shown and described in the aforesaid PCT Patent Application PCT/IL2017/050195 entitled AUTOMATED, COMPUTER-CONTROLLED COOKING SYSTEM AND METHOD, filed Feb. 15, 2017, the contents of which are hereby incorporated by reference, particularly at FIGS. 13A and 13B thereof and in the accompanying description.

It is appreciated that before cooking container 107 is inserted into operative engagement with cooking assembly 102, a bar code on cooking container 107 is preferably read by the bar code reader 109.

FIG. 19B shows the cooking container 107 fully seated in cooking container support assembly 106 interiorly of cooking assembly 102, whose cover assembly 140 remains in a fully raised operative orientation.

FIG. 19C shows the cooking container 107 fully seated in cooking container support assembly 106 interiorly of cooking assembly 102, whose cover assembly 140 is partially lowered from its fully raised operative orientation.

FIG. 19D shows the cooking container 107 fully seated in cooking container support assembly 106 interiorly of cooking assembly 102, whose cover assembly 140 is now in a fully lowered operative orientation. It is seen that in this operative orientation a bottom surface of guiding element 550 of engagement assembly 330 preferably lies in touching engagement with a top surface of cooking container 107.

It is appreciated that the foregoing steps are preferably carried out prior to electrical actuation of the cooking assembly 102, merely by a user manipulating the cover assembly 140 and placing the cooking container 107 in the cooking container support assembly 106.

Thereafter, a user actuates the cooking assembly 102 by pressing on operation initiation button 108 (FIG. 19A). This initiates cooking operation of the cooking assembly 102, as described hereinbelow with reference to FIGS. 20A and 20B.

Reference is now made FIGS. 20A and 20B, which are simplified illustrations of various stages of the cooking operation of the computer-controlled cooking system of FIG. 1-16.

Initially, as seen in FIG. 20A, operation of electric motor 600 causes the positioning assembly 150 to raise the cooking container support assembly 106 relative to cooking assembly 102, as indicated by an arrow 1210, against the urging of spring 470. This causes penetration of the cooking container 107 by liquid feeding and PSCCCCDC piercing tube 407 via guiding element 550, allowing supply of cooking liquid to the interior of cooking container 107.

The positioning assembly 150 repeatedly raises and lowers the cooking container 107 to an operative orientation shown in FIG. 20B at predetermined times during cooking, which are coordinated with the application of microwave energy to the contents of the cooking container 107 in accordance with recipes which are selected by a user or fully or partially predetermined. Cooking operation of the system described hereinabove may be similar to that described in PCT Patent Application PCT/IL2017/050195 entitled AUTOMATED, COMPUTER-CONTROLLED COOKING SYSTEM AND METHOD, filed Feb. 15, 2017, the description of which is hereby incorporated by reference. Upon termination of cooking the positioning assembly 150 is in a lowered operative orientation, such as seen in FIG. 19D.

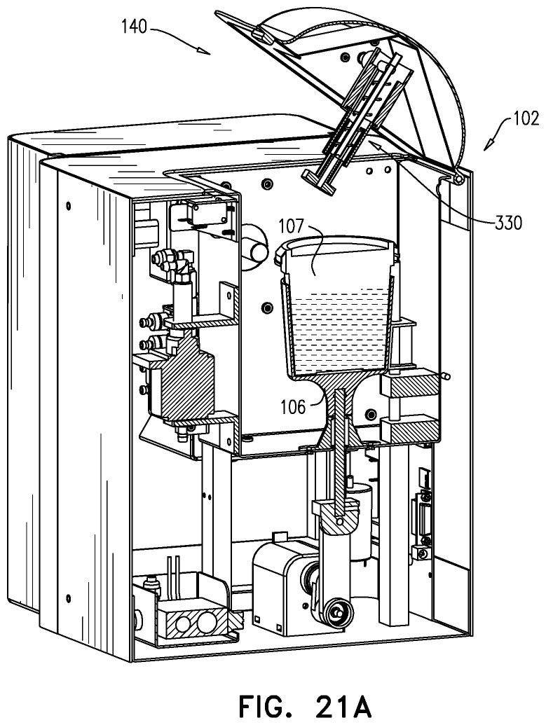

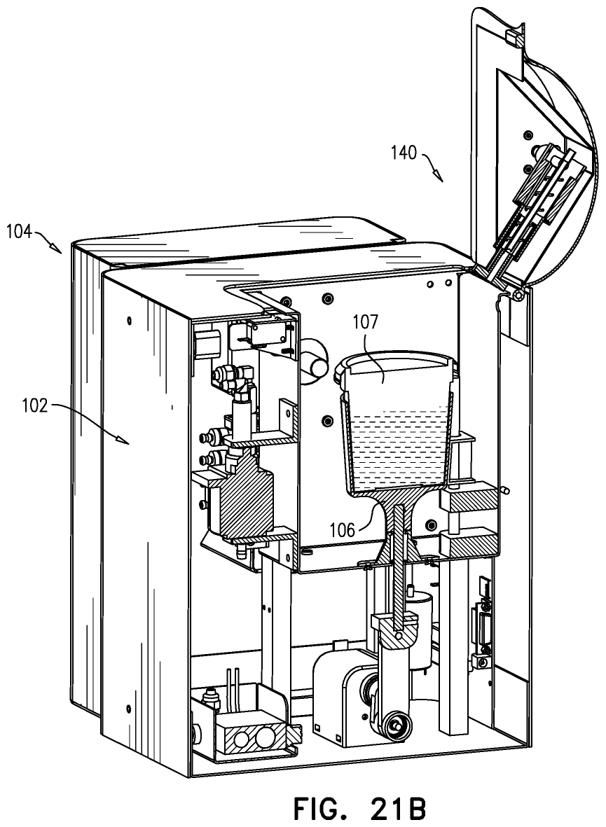

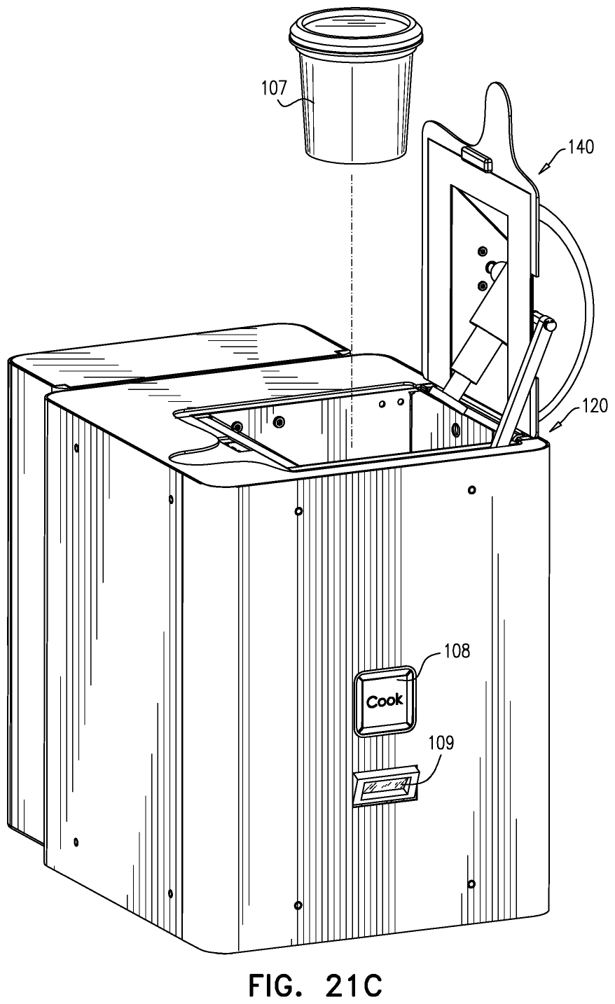

Reference is now made FIGS. 21A, 21B and 21C, which are simplified illustrations of various stages of post-cooking operation of the computer-controlled cooking system of FIG. 1-16.

FIG. 21A shows partial raising of the cover assembly 140 and disengagement of the engagement assembly 330 from the cooking container 107, which remains seated on the cooking container support assembly 106, which is in its lowered orientation.

FIG. 21B shows full raising of the cover assembly 140 with the engagement assembly 330 fully disengaged from the cooking container 107, which remains seated on the cooking container support assembly 106, is in its lowered orientation.

FIG. 21C shows removal of the cooking container 107 from the cooking container support assembly 106 and from the cooking assembly 102.

It will be appreciated by persons skilled in the art that the present invention is not limited by what has been particularly shown and described hereinabove but includes generalizations and alternatives thereof which are not shown in the prior art.

1-43. (canceled)

44. An automated, computer-controlled, cooking system in combination with user selectable ones of a plurality of different pre-sealed computerized cooking containers containing dry contents (PSCCCCDC) useful in preparing corresponding different food products, the system comprising:
a microwave radiation generator;
a computer-controlled PSCCCCDC support assembly for supporting a user-selected one of said plurality of different PSCCCCDCs during cooking and displacing said user-selected one of said plurality of different PSCCCCDCs during cooking for effecting stirring thereof;
a computer-controlled liquid supply subsystem for supplying liquid to said user selected one of said plurality of different PSCCCCDCs; and
a computer controller operative to control operation of at least said computer-controlled liquid supply subsystem, said computer-controlled PSCCCCDC support assembly and said microwave radiation generator in a predetermined sequence corresponding to and specifically adapted for cooking the contents of said user-selected one of said plurality of different PSCCCCDCs,
said plurality of different PSCCCCDCs each comprising:
a PSCCCCDC body defining a storage and cooking volume; and
a multi-ingredient, multi-sized and multi-textured dry food precursor located within said PSCCCCDC body, said multi-ingredient, multi-sized and multi-textured dry food precursor including multiple, different freeze-dried food components.

45. An automated, computer-controlled, cooking system in combination with user selectable ones of a plurality of different PSCCCCDCs useful in preparing corresponding different food products according to claim 44 and wherein said predetermined sequence defines a computer implementable cooking protocol which comprises a sequence of cooking sub-protocols each of which defines at least one parameter relating to operation of said microwave radiation generator and at least one of a parameter relating to operation of said computer-controlled liquid supply subsystem and a parameter relating to operation of said computer-controlled PSCCCCDC support assembly.

46-48. (canceled)

49. An automated, computer-controlled, cooking system in combination with user selectable ones of a plurality of different PSCCCCDCs useful in preparing corresponding different food products according to claim 44 and wherein said computer-controlled PSCCCCDC support assembly is operative to effect stirring of contents of said user selected PSCCCCDC only by moving said PSCCCCDC.

50. An automated, computer-controlled, cooking method for use with user selectable ones of a plurality of different pre-sealed computerized cooking containers containing dry contents (PSCCCCDC) useful in preparing corresponding different food products, the method comprising:
providing a user-selected one of said plurality of different PSCCCCDCs, said user-selected one of said plurality of different PSCCCCDCs comprising:
a PSCCCCDC body defining a storage and cooking volume; and
a multi-ingredient, multi-sized and multi-textured dry food precursor located within said PSCCCCDC body, said multi-ingredient, multi-sized and multi-textured dry food precursor including multiple, different freeze-dried food components;
supplying liquid to said user-selected one of said plurality of different PSCCCCDCs in accordance with a computer-controlled protocol;
producing stirring of said dry contents of said PSCCCCDC together with said liquid in accordance with said computer-controlled protocol by vertical displacement of said user-selected one of said plurality of different PSCCCCDCs;
heating of said dry contents of said PSCCCCDC together with said liquid in accordance with said computer-controlled protocol; and
controlling said supplying, said heating and said stirring in a predetermined sequence governed by said computer-controlled protocol and corresponding to and specifically adapted for cooking the contents of said user-selected one of said plurality of different pre-sealed PSCCCCDCs.

51. An automated, computer-controlled, cooking method according to claim 50 and wherein said predetermined sequence comprises a sequence of cooking sub-protocols each of which defines at least one parameter relating to said heating and at least one parameter related to at least one of said supplying and said stirring.

52. An automated, computer-controlled, cooking method according to claim 50 and wherein said stirring is effected only by said vertical displacement of said PSCCCCDC.

53. An automated, computer-controlled, cooking method according to claim 50 and wherein said stirring comprises displacing said PSCCCCDC in vertical reciprocal motion.

54. An automated, computer-controlled, cooking method according to claim 50 and also comprising controlling cooking based partially on user inputs received wirelessly and partially on a stored predetermined sequence.

55. An automated, computer-controlled, cooking method according to claim 50 and also comprising ascertaining whether cooking operations actually took place in said predetermined sequence specifically adapted for cooking the contents of said user-selected one of said plurality of different PSCCCCDCs and providing a corresponding quality control output indication.

56. An automated, computer-controlled, cooking method according to claim 55 and also comprising governing cooking in response to said quality control output indication.

57. An automated, computer-controlled, cooking method according to claim 55 and also comprising aborting cooking in response to said quality control output indication.

58. An automated, computer-controlled, cooking method according to claim 55 and also comprising automatically correcting cooking in response to said quality control output indication.

59. (canceled)

60. An automated, computer-controlled, cooking method according to claim 50 and also comprising supplying pressurized air during cooking to lower temperature and pressure within said PSCCCCDC.

61-78. (canceled)

79. An automated, computer-controlled, cooking system according to claim 44 and wherein said computer-controlled liquid supply subsystem for supplying liquid to said user selected one of said plurality of different PSCCCCDCs comprises a first water pump for pumping cold water and at least one second water pump for pumping heated water.

80. An automated, computer-controlled, cooking system according to claim 44 and wherein said computer-controlled liquid supply subsystem for supplying liquid to said user selected one of said plurality of different PSCCCCDCs comprises a heated water and/or steam generator.

81. An automated, computer-controlled, cooking system according to claim 44 and wherein said computer-controlled PSCCCCDC support assembly includes a rotary drive motor and a linkage which are together operative to displace said PSCCCCDC support in reciprocal vertical motion.

82. An automated, computer-controlled, cooking system according to claim 44 and wherein computer-controlled PSCCCCDC support assembly vertically displaces said user selected one of said plurality of different PSCCCCDCs during cooking.

83. An automated, computer-controlled, cooking system according to claim 44 and also comprising a computer-controlled quality-controller operative to ascertain whether operation of at least said computer-controlled liquid supply subsystem, said computer-controlled PSCCCCDC support assembly and said microwave radiation generator actually took place in said predetermined sequence and to provide a corresponding quality control output indication.

84. An automated, computer-controlled, cooking system according to claim 83 and wherein said computer controller is responsive to a quality control output indication which indicates an operational failure for aborting said cooking.

85. An automated, computer-controlled, cooking system according to claim 83 and wherein said computer controller is responsive to a quality control output indication which indicates an operational failure for correcting said cooking.
